(19) United States
(12) Patent Application Publication
(10) Pub. No.: US 2025/0167391 A1
(43) Pub. Date: May 22, 2025

(54) LITHIATED POLYPHOSPHAZENE SOLID POLYMER ELECTROLYTE COMPOSITIONS AND METHODS OF MANUFACTURE THEREOF

(71) Applicant: GEORGIA TECH RESEARCH CORPORATION, Atlanta, GA (US)

(72) Inventors: Gleb YUSHIN, Atlanta, GA (US); Samik JHULKI, Howrah, West Bengal (IN); Billy JOHNSON, Atlanta, GA (US); Ashwin Sankara RAMAN, Atlanta, GA (US); Kostiantin TURCHENIUK, Atlanta, GA (US)

(21) Appl. No.: 18/839,612

(22) PCT Filed: Feb. 17, 2023
(86) PCT No.: PCT/US2023/013320

§ 371 Date: Aug. 19, 2024

Related U.S. Application Data
(60) Provisional application No. 63/311,645, filed on Feb. 18, 2022.

(51) Int. Cl. H01M 50/414; C08G 79/025; H01M 10/052

(52) U.S. Cl. CPC H01M 50/414; C08G 79/025; H01M 10/052

(57) ABSTRACT

Disclosed are polymers and polymer compositions comprising metalized polyphosphazene. Also disclosed are polymer electrolytes comprising the disclosed herein polymers and polymer compositions, and film separators comprising polymers and polymer compositions. Also disclosed are batteries comprising an anode, a cathode and polymer electrolytes. Disclosed are also methods of making polymers, polymer compositions, and batteries.

### CROSS-REFERENCE TO RELATED APPLICATIONS

This application claims the benefit of U.S. Provisional Application No. 63/311,645, filed Feb. 18, 2022, the content of which is incorporated herein by reference in its entirety.

### BACKGROUND

The market for LIBs is growing rapidly, with a predicted rise over hundreds of GWh/year in the next 5-10 years, fueled by the growing adoption of electric vehicles (EVs) and renewables. Economic formation of stable, non-toxic, non-flammable solid-state LIBs would be of tremendous interest to the global community. Polymers and polymer electrolytes (solid solutions of Li-salt in polymers) could provide significant advantages for Li-ion technology due to their mechanical properties, safety, and processability in thin films. Even though it is tremendously difficult to approach the ionic conductivities of polymer electrolytes to the liquid electrolytes' values (1-10 mS cm⁻¹), some polymer electrolytes (such as polymer-in-salt concepts) do offer high ionic conductivities and high Li-ion transference number (single Li-ion). The issue with the interfacial resistance at the polymer-ceramic interface also impedes ion transport and lowers the power advantages of batteries.

Earlier research identified poly(ethyleneoxide) (PEO) as one of the few readily accessible polymers (the cost of PEO is less than $1 kg⁻¹) with a promising level of Li-ion conductivities when electrolyte salts are incorporated to form composites. First discovered in 1973, “salt-in-PEO” conducts Li⁺ ions along the polymer chains by means of formation and dissociation of coordination bonds between donor “ether oxygen” atoms and the Li⁺ ions. This “dual-ion conducting” (both Li⁺ and anion are mobile) nature of such composites made from PEO and other traditional polymer systems, such as polyamides, polycarbonates, polyesters, etc., leads to severe active material dissolution and induces concentration gradients in electrochemical cells, which limits the attainable efficiency using existing battery chemistries. Additionally, salt-in-PEO mixtures show relatively modest conductivities (especially when heated-cooled several times) due to the undesirable formation of non-conductive crystalline centers in the polymer matrix due to the high segmental motion of flexible polymer chains. In addition to the ionic conductivity, interfacial resistance, mechanical properties, and electrochemical/chemical stabilities are further obstacles that prevent the adoption of polymer electrolytes in conventional battery electrodes.

There remains a strong need to develop solid electrolytes that would offer higher Li-ion conductivities (approaching those of liquid organic electrolytes) while maintaining a large voltage window, long cycle stability, and calendar life, and, ideally, preventing Li dendrites growth from using Li metal anodes for higher energy density batteries. These needs and other needs are at least partially satisfied by the present disclosure.

### SUMMARY

The present disclosure is directed to a polymer comprising a monomer of formula (I)

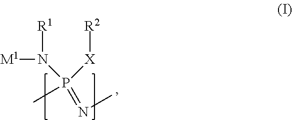

wherein R¹ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl); R² is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl); wherein R¹ and R² each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl, wherein X is O, S, or N-M¹; and wherein M¹ is Li, Na, or K.

Also disclosed herein are polymer compositions further comprising a monomer unit having formula (II):

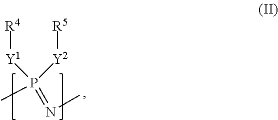

wherein R⁴ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl); R⁵ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl); wherein R⁴ and R⁵ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl, and wherein Y¹ and Y² each is independently selected from O or S.

In still further aspects, the polymer composition disclosed herein can further comprise formula (III)

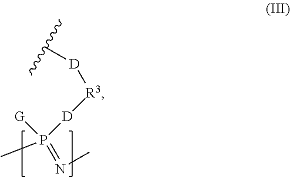

wherein a wavy line is a representative bond to a polymer chain, wherein G is R¹—N—, R²—X—, R⁴—Y—, or R⁵—Y—, D is O, S, N, R³ is a linking group R³ is a linking group selected from alkenylene, alkylene, arylene, wherein each of alkenylene, alkylene, arylene, is optionally substituted by with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl.

In yet still further aspects disclosed herein a polymer composition comprising any of the disclosed herein polymers.

Also disclosed herein is an electrolyte comprising any of the disclosed herein polymers or polymer compositions.

Also disclosed herein is a separator comprising any of the disclosed herein polymers or polymer compositions.

In still further aspects, disclosed herein is a composition comprising a blend of any of the disclosed herein polymers or polymer compositions and an electrode material.

In still further aspects, disclosed herein is a battery comprising an anode material, a cathode material, and an electrolyte comprising from greater than 0 wt % to 100% of any of the disclosed herein polymers or polymer compositions.

Also disclosed herein are methods of making of any of the disclosed herein polymers, polymer compositions, and batteries.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and is not restrictive of the invention, as claimed.

### DESCRIPTION OF DRAWINGS

FIG. 1 illustrates a general schematic for the conversion of polydichlorophosphazene (A) into poly(organophosphazenes) (B), followed by the lithiation reaction and formation of lithiated polyphosphazenes (C).

FIG. 2 illustrates an exemplary synthesis protocol of poly(organophosphazenes) of formula 2, 4, and 6, followed by the lithiation reactions and formation of lithiated polyphosphazenes 3, 5 and 7.

FIG. 3 illustrates an exemplary separator in which the components, materials, methods, and other techniques described herein, or combinations thereof, may be applied according to various aspects.

FIG. 4 illustrates an example of a battery separator with ceramic nanowires reinforcement in which the components, materials, methods, and other techniques described herein, or combinations thereof, may be applied according to various aspects.

FIG. 5 illustrates an example of a Li-ion battery in which the components, materials, methods, and other techniques described herein, or combinations thereof, may be applied according to various aspects.

FIG. 6 illustrates an example of a Li-ion battery with a separator having ceramic nanowires reinforcement, in which the components, materials, methods, and other techniques described herein, or combinations thereof, may be applied according to various aspects.

FIG. 7 illustrates an example of a Li-metal battery in which the components, materials, methods, and other techniques described herein, or combinations thereof, may be applied according to various aspects.

FIG. 8 illustrates an example of a Li-metal battery with a separator with ceramic nanowires reinforcement in which the components, materials, methods, and other techniques described herein, or combinations thereof, may be applied according to various aspects.

FIG. 9 illustrates the transformation of hexachlorophosphazene into poly(dichlorophosphazene) 1 using 260° C. for 4-6h in the presence of catalytic AlCl3, a procedure that entails modified conditions of thermal ring-opening polymerization.

FIG. 10 illustrates an example of a transformation of poly(dichlorophosphazene) 1 into polymer 2a.

FIG. 11 illustrates a 1H NMR spectrum of poly(bis(2-methoxyethylamido)phosphazene) 2a.

FIG. 12 illustrates a 31P NMR spectrum of 2a.

FIG. 13 illustrates a 13C NMR spectrum of 2a.

FIG. 14 illustrates an example of a lithiation reaction of polymer 2a into poly(bis(2-methoxyethylamidolithium)phosphazene) 3a.

FIG. 15 illustrates a 1H NMR spectrum of 3a.

FIG. 16 illustrates a 31P NMR spectrum of 3a.

FIG. 17 illustrates a 13C NMR spectrum of 3a.

FIG. 18 illustrates a 7Li NMR spectrum of 3a.

FIG. 19 illustrates an exemplary transformation of poly(disclorophosphazene) 1 into poly(bis(3-methoxypropylamido)phosphazene) 2b.

FIG. 20 illustrates a 1H NMR spectrum of 2b.

FIG. 21 illustrates a 31P NMR spectrum of 2b.

FIG. 22 illustrates a 13C NMR spectrum of 2b.

FIG. 23 illustrates an example of a lithiation reaction of polymer 2b into poly(bis(3-methoxypropylamidolithium)phosphazene) 3b.

FIG. 24 illustrates a 1H NMR spectrum of 3b.

FIG. 25 illustrates a 31P NMR spectrum of 3b.

FIG. 26 illustrates a 13C NMR spectrum of b.

FIG. 27 illustrates a 7Li NMR spectrum of 3b.

FIG. 28 illustrates an example of a transformation of poly(dichlorophosphazene) 1 into poly(bis(2,2,2-trifluoroethylanido)phosphazene) b.

FIG. 29 illustrates a 1H NMR spectrum of 2c.

FIG. 30 illustrates a 31P NMR spectrum of 2c.

FIG. 31 illustrates a 13C NMR spectrum of 2c.

FIG. 32 illustrates a 19F NMR spectrum of 2c.

FIG. 33 illustrates an example of a lithiation reaction of polymer 2c into poly(bis(2,2,2-trifluoroethylamidolithium)phosphazene) 3c.

FIG. 34 illustrates a 1H NMR spectrum of 3c.

FIG. 35 illustrates a 31P NMR spectrum of 3c.

FIG. 36 illustrates a 13C NMR spectrum of 3c.

FIG. 37 illustrates a 7Li NMR spectrum of 3c.

FIG. 38 illustrates a 19F NMR spectrum of 3c.

FIG. 39 illustrates an example of a transformation of poly(dichlorophosphazene) 1 into polymer 1a followed by the formation of the poly((2-(2-methoxyethoxy)ethoxy)(2-methoxyethylamido)phosphazene) 6a.

FIG. 40 illustrates a 1H NMR spectrum of 6a.

FIG. 41 illustrates a 31P NMR spectrum of 6a.

FIG. 42 illustrates a 13C NMR spectrum of 6a.

FIG. 43 illustrates an example of a lithiation reaction of polymer 6a into poly((2-(2-methoxyethoxy)ethoxy)(2-methoxyethylamidolithium)phosphazene) 7a.

FIG. 44 illustrates a 1H NMR spectrum of 7a.

FIG. 45 illustrates a 31P NMR spectrum of 7a.

FIG. 46 illustrates a 7Li NMR spectrum of 7a.

FIG. 47 illustrates an example of a transformation of poly(dichlorophosphazene) 1 into polymer 1b followed by the formation of the poly((2-(2-methoxyethoxy)ethoxy)(2-methoxyethylamido)phosphazene) 6b.

FIG. 48 illustrates a 1H NMR spectrum of 6b.

FIG. 49 illustrates a 31P NMR spectrum of 6b.

FIG. 50 illustrates a 130C NMR spectrum of 6b.

FIG. 51 illustrates an example of a lithiation reaction of polymer 6b into poly((2-(2-methoxyethoxy)ethoxy)(2-methoxyethylamidolithium)phosphazene) 7b.

FIG. 52 illustrates a 1H NMR spectrum of 7b.

FIG. 53 illustrates a 31P NMR spectrum of 7b.

FIG. 54 illustrates a 7Li NMR spectrum of 7b.

FIG. 55 illustrates a method for preparation of SLiC-SPE comprised of 3a, 3b, or 3c blended with PEO. Prepared by dissolving the lithiated polyphosphazene in dimethyl sulfoxide and separately dissolved PEO in acetonitrile and combining the two solutions before casting via DR blade on a PTFE sheet and drying thoroughly.

FIGS. 56A-56B illustrate a temperature dependence of ionic conductivity in all the lithiated polyphosphazene (3a, 3b, and 3c) blended polymer electrolytes ([EO]:[Li+]=10:1 for all) with linear fits corresponding to amorphous PEO regions above 60° C. and semi-crystalline PEO below 60° C. (FIG. 56A), ionic conductivities of PEO-3c polymer electrolytes with different [EO]:[Li+] ratios (FIG. 56B).

FIGS. 57A-57B illustrate DSC data (FIG. 57A) and TGA traces of PEO-3c SPEs at various [EO]:[Li+] ratios (FIG. 57B).

FIG. 58 illustrates a linear sweep voltammogram of 10:1 PEO-3c SLiC-SPE from OCV to 5.5 V at 0.2 mV·s-1 (inset: an optical image of PEO-3c membrane).

FIG. 59 illustrates a chronoamperogram of a Li\PEO-3c\Li symmetric cell with a 10 mV bias voltage; I₀ and I_{SS} represent initial and steady-state currents, respectively, with Nyquist plots before and after polarization (inset).

FIG. 60 illustrates a cell construction showing PEO-3c utilized as a binder as well as SLiC-SPE/separator promoting ionic conductivity throughout the cell, (b) FESEM micrograph of LFP cathodes, and (c) FESEM cross-section of LFP cathode with SLiC-SPE binder.

FIGS. 61A-61D illustrate the cycling performance of LiFePO4|PEO-3c|Li cell 0.05 C (FIG. 61A) and 0.2 C at 100° C. (FIG. 61C), and charge-discharge curves of LiFePO4 cathodes with PEO-3c SLiC-SPE at 0.05 C (FIG. 61B) and 0.2 C (FIG. 61D).

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” means that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a monomer” includes two or more monomers, reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The term “or” means “and/or.” Recitation of ranges of values is merely intended to serve as a shorthand method of referring individually to each separate value falling within the range unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

Recitation of ranges of values herein is merely intended to serve as a shorthand method of referring individually to each separate value recited or falling within the range unless otherwise indicated herein, and each separate value is incorporated into the specification as if it were individually recited. Ranges provided herein are understood to be shorthand for all of the values within the range. For example, a range of 1 to 50 is understood to include any number, or combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40,41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

The organic moieties mentioned when defining variable positions within the general formulae described herein (e.g., the term “halogen”) are collective terms for the individual substituents encompassed by the organic moiety. The prefix Cₙ₋ₘ preceding a group or moiety indicates, in each case, the possible number of carbon atoms in the group or moiety that follows.

The term “ion,” as used herein, refers to any molecule, portion of a molecule, a cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, a portion of a molecule, a cluster of molecules, a molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), a cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), a cluster of molecules, molecular complex, moiety, or atom, containing a net positive charge or that can be made to contain a net positive charge. The term “cation precursor” is used herein to specifically refer to a molecule that can be converted to a cation via a chemical reaction (e.g., protonation or alkylation).

As used herein, the term “substituted” means that a hydrogen atom is removed and replaced by a substituent. It is contemplated to include all permissible substituents of organic compounds. As used herein, the phrase “optionally substituted” means unsubstituted or substituted. It is understood that substitution at a given atom is limited by valency. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with a permitted valence of the substituted atom and the substituent and that the substitution results in a stable compound, e.g., a compound that does not spontaneously undergo transformation such as by rearrangement, cyclization, elimination, etc. In still further aspects, it is understood that when the disclosure describes a group being substituted, it means that the group is substituted with one or more (i.e., 1, 2, 3, 4, or 5) groups as allowed by valence selected from alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

“Z¹,” “Z²,” “Z³,” and “Z⁴” are used herein as generic symbols to represent various specific substituents. In certain aspects, the generic symbols to represent various specific substituents can be marked as “R¹,” “R²,” “R³,” or “Rⁿ,” wherein n is a subsequent number of substituents. These symbols can be any substituent, not limited to those disclosed herein, and when they are defined to be certain substituents in one instance, they can, in another instance, be defined as some other substituents.

The expressions “ambient temperature” and “room temperature” as used herein are understood in the art and refer generally to a temperature, e.g., a reaction temperature, that is about the temperature of the room in which the reaction is carried out, for example, a temperature from about 20° C. to about 30° C.

A dash (“-”) that is not between two letters or symbols is used to indicate a point of attachment for a substituent. For example, —(C═O)NH₂ is attached through carbon of the keto (C═O) group.

The term “aliphatic,” as used herein, refers to a non-aromatic hydrocarbon group and includes branched and unbranched, alkyl, alkenyl, or alkynyl groups. As used herein, the term “Cₙ-Cₘ alkyl” (or “Cₙ₋ₘ”) employed alone or in combination with other terms refers to a saturated hydrocarbon group that may be straight-chain or branched, having n to m carbons. It is understood that the terms Cₙ₋ₘ and Cₙ-Cₘ can be used interchangeably and just to show that the specific compound has between n to m carbons. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl moieties include, but are not limited to, chemical groups such as methyl, ethyl, n-propyl, isopropyl, n-butyl, teri-butyl, isobutyl, sec-butyl; higher homologs such as 2-methyl-I-butyl, n-pentyl, 3-pentyl, n-hexyl, 1,2,2-trimethylpropyl, heptyl, octyl, nonyl, decyl, dodecyl, tetradecyl, hexadecyl, eicosyl, tetracosyl, and the like. The alkyl group can also be substituted or unsubstituted. Throughout the specification, “alkyl” is generally used to refer to both unsubstituted alkyl groups and substituted alkyl groups; however, substituted alkyl groups are also specifically referred to herein by identifying the specific substituent(s) on the alkyl group. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below, provided that the substituents are sterically compatible and the rules of chemical bonding and strain energy are satisfied. It is further understood that throughout the specification, “alkyl” can also be referred to as a linking group of saturated hydrocarbons that are divalent radicals. In other words, in a broader description, the term “alkyls” also encompasses alkylenes.

The term “heteroaliphatic” refers to an aliphatic moiety that contains at least one heteroatom in the chain, for example, an amine, carbonyl, carboxy, oxo, thio, phosphate, phosphonate, nitrogen, phosphorus, silicon, or boron atoms in place of a carbon atom. In certain aspects, the only heteroatom is nitrogen. In certain aspects, the only heteroatom is oxygen. In certain aspects, the only heteroatom is sulfur. “Heteroaliphatic” is intended herein to include, but is not limited to, heteroalkyl, heteroalkenyl, heteroalkynyl, heterocycloalkyl, heterocycloalkenyl, and heterocycloalkynyl moieties. In certain aspects, “heteroaliphatic” is used to indicate a heteroaliphatic group (cyclic, acyclic, substituted, unsubstituted, branched, or unbranched) having 1-20 carbon atoms. In certain aspects, the heteroaliphatic group is optionally substituted in a manner that results in the formation of a stable moiety. Nonlimiting examples of heteroaliphatic moieties are polyethylene glycol, polyalkylene glycol, amide, polyamide, polylactide, polyglycolide, thioether, and ether, alkyl-heterocycle-alkyl, —O-alkyl-O-alkyl, alkyl-O-haloalkyl, etc.

Throughout the specification, “alkyl” is generally used to refer to both unsubstituted alkyl groups and substituted alkyl groups; however, substituted alkyl groups are also specifically referred to herein by identifying the specific substituent(s) on the alkyl group.

For example, the term “halogenated alkyl” specifically refers to an alkyl group that is substituted with one or more halides, e.g., fluorine, chlorine, bromine, or iodine. Haloalkyl” is a branched or straight-chain alkyl group substituted with 1 or more halo atoms described above, up to the maximum allowable number of halogen atoms. Examples of haloalkyl groups include, but are not limited to, fluoromethyl, difluoromethyl, trifluoromethyl, chloromethyl, dichloromethyl, trichloromethyl, pentafluoroethyl, heptafluoropropyl, difluorochloromethyl, dichlorofluoromethyl, difluoroethyl, difluoropropyl, dichloroethyl and di chloropropyl. “Perhaloalkyl” means an alkyl group having all hydrogen atoms replaced with halogen atoms. Examples include but are not limited to trifluoromethyl and pentafluoroethyl.

The term “alkoxyalkyl” specifically refers to an alkyl group that is substituted with one or more alkoxy groups, as described below. The term “alkylamino” specifically refers to an alkyl group that is substituted with one or more amino groups, as described below and the like. When “alkyl” is used in one instance, and a specific term such as “alkylalcohol” is used in another, it is not meant to imply that the term “alkyl” does not also refer to specific terms such as “alkylalcohol” and the like.

As used herein, “Cₙ-Cₘ alkenyl” refers to an alkyl group having one or more double carbon-carbon bonds and having n to m carbons. Alkenyls can be straight-chained or branched. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Examples of alkenyl groups include, but are not limited to, ethenyl, n-propenyl, isopropenyl, n-butenyl, seobutenyl, and the like. In various aspects, the alkenyl moiety contains 2 to 6, 2 to 4, or 2 to 3 carbon atoms. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, thiol, or phosphonyl, as described below. It is understood that alkenyl groups can be used as a linking group, in such aspects, the broad definition of the alkenyl group also includes divalent alkenylene groups.

As used herein, “Cₙ-Cₘ alkynyl” refers to an alkyl group having one or more triple carbon-carbon bonds and having n to m carbons. Alkynyls can be straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. In various aspects, the alkynyl moiety contains 2 to 6, 2 to 4, or 2 to 3 carbon atoms. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, or phosphonyl, as described below.

As used herein, the term “Cₙ-Cₘ alkylene,” employed alone or in combination with other terms, refers to a divalent alkyl linking group having n to m carbons. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like. In various aspects, the alkylene moiety contains 2 to 6, 2 to 4, 2 to 3, 1 to 6, 1 to 4, or 1 to 2 carbon atoms. It is understood that in certain aspects, alkylene can also be referred to as alkyl in a broader scope of the definition, with the understanding that if it is a linking group, it provides two bonds.

As used herein, the term “Cₙ-Cₘ alkoxy,” employed alone or in combination with other terms, refers to a group of formula —O-alkyl, wherein the alkyl group has n to m carbons. In other words, the term alkoxy, as used herein, is an alkyl group bound through a single, terminal ether linkage; that is, an “alkoxy” group can be defined as a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy. In other aspects, an example of alkoxy groups includes methoxy, ethoxy, propoxy (e.g., w-propoxy and isopropoxy), teri-butoxy, and the like. In various aspects, the alkyl group has 1 to 6, 1 to 4, or 1 to 3 carbon atoms.

The term “cyclic group” is used herein to refer to either aryl groups or non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups. It is understood that if this cyclic group is a linking group, aryl groups can include in broader scope arylenes if they behave as linking groups.

As used herein, “aryl” refers to a radical of a monocyclic or polycyclic (e.g., bicyclic or tricyclic) 4n+2 aromatic ring system (e.g., having 6, 10, or 14 it electrons shared in a cyclic array) having 6-14 ring carbon atoms and zero heteroatoms provided in the aromatic ring system (“C₆₋₁₄ aryl”). In some aspects, an aryl group has 6 ring carbon atoms (“C₆ aryl”; e.g., phenyl). In some aspects, an aryl group has 10 ring carbon atoms (“C₁₀ aryl”; e.g., naphthyl such as 1-naphthyl and 2-naphthyl). In some aspects, an aryl group has 14 ring carbon atoms (“C₁₄ aryl”; e.g., anthracyl). “Aryl” also includes ring systems wherein the aryl ring, as defined above, is fused with one or more cycloalkyl or heterocycle groups wherein the radical or point of attachment is on the aryl ring, and in such instances, the number of carbon atoms continues to designate the number of carbon atoms in the aryl ring system. One or more fused cycloalkyl or heterocycle groups can be 4 to 7-member saturated or partially unsaturated cycloalkyl or heterocycle groups. It is understood that when an aryl group is used as a linking group, in a broad sense, it includes arylenes.

“Arylalkyl” refers to either an alkyl group as defined herein substituted with an aryl group as defined herein or to an aryl group as defined herein substituted with an alkyl group as defined herein.

The term “heterocycle” denotes saturated and partially saturated heteroatom-containing ring radicals wherein there are 1, 2, 3, or 4 heteroatoms independently selected from nitrogen, sulfur, boron, silicone, and oxygen. Heterocyclic rings may comprise monocyclic 3-10 membered rings, as well as 5-16 membered bicyclic ring systems (which can include bridged, fused, and spiro-fused bicyclic ring systems). It does not include rings containing —O—O—, —O—S— or —S—S— portions. Examples of saturated heterocycle groups include saturated 3- to 6-membered heteromonocyclic groups containing 1 to 4 nitrogen atoms [e.g., pyrrolidinyl, imidazolidinyl, piperidinyl, pyrrolinyl, piperazinyl]; saturated 3 to a 6-membered heteromonocyclic group containing 1 to 2 oxygen atoms and 1 to 3 nitrogen atoms [e.g., morpholinyl]; saturated 3 to 6-membered heteromonocyclic group containing 1 to 2 sulfur atoms and 1 to 3 nitrogen atoms [e.g., thiazolidinyl]. Examples of partially saturated heterocycle radicals include but are not limited to dihydrothienyl, dihydropyranyl, dihydrofuryl, and dihydrothiazolyl. Examples of partially saturated and saturated heterocycle groups include but are not limited to pyrrolidinyl, imidazolidinyl, piperidinyl, pyrrolinyl, pyrazolidinyl, piperazinyl, morpholinyl, tetrahydropyranyl, thiazolidinyl, dihydrothienyl, 2,3-dihydro-benzo[1,4]dioxanyl, indolinyl, isoindolinyl, dihydrobenzothienyl, dihydrobenzofuryl, isochromanyl, chromanyl, 1,2-dihydroquinolyl, 1,2, 3, 4-tetrahydro-isoquinolyl, 1,2,3,4-tetrahydro-quinolyl, 2, 3, 4, 4a, 9,9a-hexahydro-1H-3-aza-fluorenyl, 5,6,7-trihydro-1, 2, 4-triazolo[3,4-a]isoquinolyl, 3,4-dihydro-2H-benzo[1,4]oxazinyl, benzo[1,4]dioxanyl, 2,3-dihydro-1H-1λ′-benzo[d]isothiazol-6-yl, dihydropyranyl, dihydrofuryl, and dihydrothiazolyl.

“Heterocycle” also includes groups wherein the heterocyclic radical is fused/condensed with an aryl or carbocycle radical, wherein the point of attachment is the heterocycle ring. “Heterocycle” also includes groups wherein the heterocyclic radical is substituted with an oxo group (i.e.

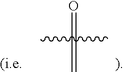 [SMILES: *=O]

For example, a partially unsaturated condensed heterocyclic group containing 1 to 5 nitrogen atoms, for example, indoline or isoindoline; a partially unsaturated condensed heterocyclic group containing 1 to 2 oxygen atoms and 1 to 3 nitrogen atoms; a partially unsaturated condensed heterocyclic group containing 1 to 2 sulfur atoms and 1 to 3 nitrogen atoms; and a saturated condensed heterocyclic group containing 1 to 2 oxygen or sulfur atoms.

The term “heterocycle” also includes “bicyclic heterocycle.” The term “bicyclic heterocycle” denotes a heterocycle as defined herein wherein there is one bridged, fused, or spirocyclic portion of the heterocycle. The bridged, fused, or spirocyclic portion of the heterocycle can be a carbocycle, heterocycle, or aryl group as long as a stable molecule results. Unless excluded by context, the term “heterocycle” includes bicyclic heterocycles. Bicyclic heterocycle includes groups wherein the fused heterocycle is substituted with an oxo group. Non-limiting examples of bicyclic heterocycles include:

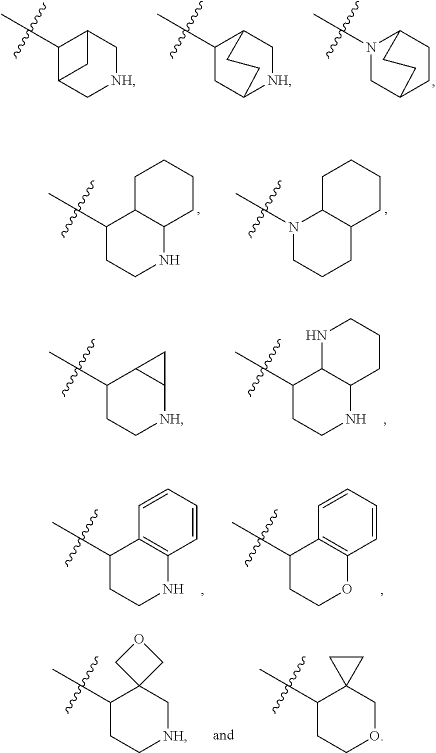

“Heterocyclealkyl” refers to either an alkyl group as defined herein substituted with a heterocycle group as defined herein or to a heterocycle group as defined herein substituted with an alkyl group as defined herein.

The term “heteroaryl” denotes stable aromatic ring systems that contain 1, 2, 3, or 4 heteroatoms independently selected from O, N, and S, wherein the ring nitrogen and sulfur atom(s) are optionally oxidized, and the nitrogen atom(s) are optionally quarternized. Examples include but are not limited to, unsaturated 5 to 6 membered heteromonocyclyl groups containing 1 to 4 nitrogen atoms, such as pyrrolyl, imidazolyl, pyrazolyl, 2-pyridyl, 3-pyridyl, 4-pyridyl, pyrimidyl, pyrazinyl, pyridazinyl, triazolyl [e.g., 4H-I,2,4-triazolyl, H4-1,2,3-triazolyl, 2H-I,2,3-triazolyl]; unsaturated 5- to 6-membered heteromonocyclic groups containing an oxygen atom, for example, pyranyl, 2-furyl, 3-furyl, etc.; unsaturated 5 to 6-membered heteromonocyclic groups containing a sulfur atom, for example, 2-thienyl, 3-thienyl, etc.; unsaturated 5- to 6-membered heteromonocyclic groups containing 1 to 2 oxygen atoms and 1 to 3 nitrogen atoms, for example, oxazolyl, isoxazolyl, oxadiazolyl [e.g., 1,2,4-oxadiazolyl, 1,3,4-oxadiazolyl, 1,2,5-oxadiazolyl]; unsaturated 5 to 6-membered heteromonocyclic groups containing 1 to 2 sulfur atoms and 1 to 3 nitrogen atoms, for example, thiazolyl, thiadiazolyl [e.g., 1,2,4-thiadiazolyl, 1,3,4-thiadiazolyl, 1,2,5-thiadiazolyl], In certain aspects the “heteroaryl” group is a 8, 9, or 10 membered bicyclic ring system. Examples of 8, 9, or 10-membered bicyclic heteroaryl groups include benzofurazanyl, benzothiophenyl, benzothiazolyl, benzoxazolyl, quinazolinyl, quinoxalinyl, naphthyridinyl, quinolinyl, isoquinolinyl, benzofuranyl, indolyl, indazolyl, and benzotri azolyl.

“Heteroaryl alkyl” refers to either an alkyl group as defined herein substituted with a heteroaryl group as defined herein or to a heteroaryl group as defined herein substituted with an alkyl group as defined herein.

As used herein, “carbocyclic,” “carbocycle,” or “cycloalkyl” includes a saturated or partially unsaturated (i.e., not aromatic) group containing all carbon ring atoms and from 3 to 14 ring carbon atoms (“C₃₋₁₄ cycloalkyl”) and zero heteroatoms in the non-aromatic ring system. In some aspects, a cycloalkyl group has 3 to 10-ring carbon atoms (“C3-10 cycloalkyl”). In some aspects, a cycloalkyl group has 3 to 9 ring carbon atoms (“C3-9 cycloalkyl”). In some aspects, a cycloalkyl group has 3 to 8-ring carbon atoms (“C3-8 cycloalkyl”). In some aspects, a cycloalkyl group has 3 to 7-ring carbon atoms (“C3-7 cycloalkyl”). In some aspects, a cycloalkyl group has 3 to 6-ring carbon atoms (“C3-6 cycloalkyl”). In some aspects, a cycloalkyl group has 4 to 6-ring carbon atoms (“C4-6 cycloalkyl”). In some aspects, a cycloalkyl group has 5 to 6-ring carbon atoms (“C5-6 cycloalkyl”). In some aspects, a cycloalkyl group has 5 to 10 ring carbon atoms (“C5-10 cycloalkyl”). Exemplary C3-6 cycloalkyl groups include, without limitation, cyclopropyl (C3), cyclopropenyl (C3), cyclobutyl (C4), cyclobutenyl (C4), cyclopentyl (C5), cyclopentenyl (C5), cyclohexyl (C6), cyclohexenyl (C6), cyclohexadienyl (C7), and the like. Exemplary C3-8 cycloalkyl groups include, without limitation, the aforementioned C3-6 cycloalkyl groups as well as cycloheptyl (C7) and cycloheptenyl (C7), cycloheptadienyl (C7), cycloheptatrienyl (C7), cyclooctyl (C8), cyclooctenyl (C8), and the like. Exemplary C3-10 cycloalkyl groups include, without limitation, the aforementioned C3-8 cycloalkyl groups as well as cyclononyl (C9) and cyclononenyl (C9), cyclodecyl (C10), cyclodecenyl (C10), and the like. As the foregoing examples illustrate, in certain aspects, the cycloalkyl group can be saturated or can contain one or more carbon-carbon double bonds. The term “cycloalkyl” also includes ring systems wherein the cycloalkyl ring, as defined above, is fused with one heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes ring systems wherein the cycloalkyl ring, as defined above, has a spirocyclic heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes bicyclic or polycyclic fused, bridged, or spiro ring systems that contain from 5 to 14 carbon atoms and zero heteroatoms in the non-aromatic ring system. Representative examples of “cycloalkyl” include, but are not limited to,

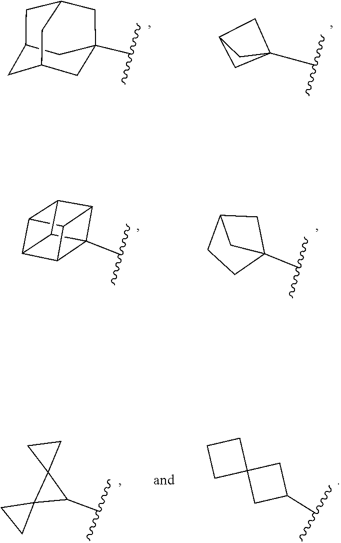 [SMILES: *C12CC3CC(CC(C3)C1)C2 ; *C12CC(C1)C2 ; *C12C3C4C5C3C1C5C42 ; *C12CCC(C1)C2 ; *C1C2(CC2)C12CC2 ; *C1CC2(CCC2)C1]

The term “bicycle” refers to a ring system wherein two rings are fused together, and each ring is independently selected from carbocycle, heterocycle, aryl, and heteroaryl. Non-limiting examples of bicycle groups include:

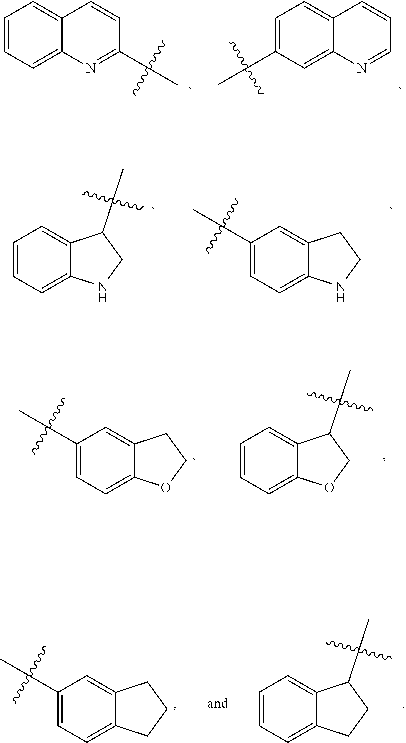

The terms “amine” or “amino” as used herein are represented by the formula —NR¹R², where R¹ and R² can each be substitution groups as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NR¹R².

The term “anhydride” as used herein is represented by the formula Z¹C(O)OC(O)Z², where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride,” as used herein, is represented by the formula:

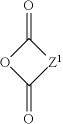

where Z¹ can be an alkyl, alkenyl, alkynyl, aryl, heteroaryl, cycloalkyl, cycloalkenyl, heterocycloalkyl, or heterocycloalkenyl group described above.

The term “azide,” as used herein, is represented by the formula —N═N═N.

The term “aldehyde,” as used herein, is represented by the formula —C(O)H. Throughout this specification, “C(O)” or “CO” is a shorthand notation for C═O, which is also referred to herein as a “carbonyl.”

The term “carboxylic acid,” as used herein, is represented by the formula —C(O)OH. A “carboxylate” or “carboxyl” group, as used herein, is represented by the formula —C(O)O

The term “ester” as used herein is represented by the formula —OC(O)R¹ or —C(O)OR¹, where R¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula R¹OR², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three-atom ring and can be represented by the formula:

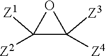

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above.

The term “ketone” as used herein is represented by the formula R¹C(O)R², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide,” or “halogen,” or “halo,” as used herein, refers to fluorine, chlorine, bromine, and iodine.

The term “hydroxyl,” as used herein, is represented by the formula —OH.

The term “nitro,” as used herein, is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide,” as used herein, comprises the formula —S—.

As used herein, the term “thio” refers to a group of formulas —SH.

As used herein, the term “Cₙ-Cₘ alkylthio” refers to a group of formula —S-alkyl, wherein the alkyl group has n to m carbon atoms. In various aspects, the alkyl group has 1 to 6, 1 to 4, or 1 to 3 carbon atoms.

As used herein, the term “Cₙ-Cₘ alkylsulfonyl” refers to a group of formula —S(O)— alkyl, wherein the alkyl group has n to m carbon atoms. In various aspects, the alkyl group has 1 to 6, 1 to 4, or 1 to 3 carbon atoms.

As used herein, the term “Cₙ-Cₘ alkylsulfonyl” refers to a group of formula —S(O)₂-alkyl, wherein the alkyl group has n to m carbon atoms. In various aspects, the alkyl group has 1 to 6, 1 to 4, or 1 to 3 carbon atoms.

As used herein, the term “carbamyl” refers to a group of formula —C(O)NH₂.

As used herein, the term “carbonyl,” employed alone or in combination with other terms, refers to a —C(═O)— group, which may also be written as C(O).

As used herein, the term “carboxy” refers to a group of formula —C(O)OH.

As used herein, “halogen” refers to F, Cl, Br, or I.

The term “sulfonylamino” or “sulfonamide,” as used herein, is represented by the formula —S(O)₂NH—.

“R¹,” “R²,” “R³,” “Rⁿ,” etc., where n is some integer, as used herein, can independently possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within the second group, or alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated contrary, a formula with chemical bonds shown only as solid lines and not as wedges or dashed lines contemplates each possible stereoisomer or a mixture of stereoisomer (e.g., each enantiomer, each diastereomer, each meso compound, a racemic mixture, or scalemic mixture).

“Phase,” as used herein, generally refers to a region of a material having a substantially uniform composition which is a distinct and physically separate portion of a heterogeneous system. The term “phase” does not imply that the material making up a phase is a chemically pure substance but merely that the chemical and/or physical properties of the material making up the phase are essentially uniform throughout the material and that these chemical and/or physical properties differ significantly from the chemical and/or physical properties of another phase within the material. Examples of physical properties include density, thickness, aspect ratio, specific surface area, porosity, dimensionality, stretchability, modulus, and ionic conductivity. Examples of chemical properties include chemical composition.

The term “olefinically unsaturated group” or “ethylenically unsaturated group” is employed herein in a broad sense and is intended to encompass any groups containing a carbon-carbon double-bonded group (>C═C<group). Exemplary ethylenically unsaturated groups include, but are not limited to, (meth)acrylate, (meth)acrylamide, (meth)acryloyl, allyl, vinyl, styrenyl, or other >C═C<containing groups.

“Polymer” means a material formed by polymerizing one or more monomers.

The term “(co)polymer” includes homopolymers, copolymers, or mixtures thereof.

The term “(meth)acryl . . . ” includes “acryl . . . ,” “methacryl . . . ,” or mixtures thereof.

The term prepolymer is used herein to refer to a polymer that has reactive groups that are available for bond-forming reactions that will crosslink (intermolecular and/or intramolecular crosslink). It is not meant to imply that the prepolymer is not yet a polymer (e.g., a monomer or polymer precursor). Rather, a “prepolymer” refers to a starting polymer which contains multiple crosslinkable groups and can be cured (e.g., crosslinked) to obtain a crosslinked polymer having a molecular weight higher than the starting polymer.

“Molecular weight” of a polymeric material (including monomeric or macro-monomeric materials), as used herein, refers to the number-average molecular weight as measured by ¹H NMR spectroscopy unless otherwise specifically noted or unless testing conditions indicate otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example aspects.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

In other aspects, as used herein, the term “substantially free,” when used in the context of a surface substantially free of defects or substantially free of dendrites, for example, is intended to refer to a surface that has less than about 5% of defects or dendrites, less than about 4.5% of defects or dendrites, less than about 4% of defects or dendrites, less than about 3.5% of defects or dendrites, less than about 3% of defects or dendrites, less than about 2.5% of defects or dendrites, less than about 2% of defects or dendrites, less than about 1.5% of defects or dendrites, less than about 1% of defects or dendrites, less than about 0.5% of defects or dendrites, less than about 0.1% of defects or dendrites, less than about 0.05% of defects, or less than about 0.01% of defects or dendrites of the total surface.

As used herein, the designation of a polymeric or oligomeric system having the formula:

-[Unit A]ₓ-[Unit B]_{y}—

indicates that the polymer or oligomer is composed of the depicted units in the ratio specified by the x and y subscript, but in the absence of an indication to the contrary, it does not imply any particular order or arrangement of the units. By way of example, the formula:

-[Unit A]₂-[Unit B]₃—

includes, but is not limited to:

-[Unit B]—[Unit A]-[Unit B]—[Unit A]-[Unit B];

-[Unit B]—[Unit B]—[Unit B]—[Unit A]-[Unit A]; and

-[Unit B]—[Unit B]—[Unit A]-[Unit A]-[Unit B].

The subscript units typically refer to the relative ratio of the individual monomer units used to prepare the polymeric or oligomeric system, assuming 100% conversion of the monomer unit that is the limiting reagent. The relative ratio can be expressed as a weight ratio, mole ratio, or volume ratio.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Polymers and Polymer Compositions

In some aspects, disclosed herein is a polymer comprising a monomer of formula (I)

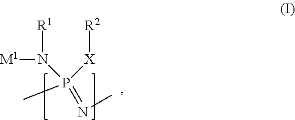

wherein
R¹ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl);
R² is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl);
wherein R¹ and R² each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁-13 heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl, wherein X is O, S, or N-M¹; and wherein M¹ is Li, Na, or K.

In still further aspects, it is understood that if the polymer described herein comprises monomers that have X comprising a nitrogen element, not all of these nitrogen-containing groups can undergo full metallization and therefore disclosed herein are also monomers where some of the X are N—H.

In still further aspects, the monomer (I) is a monomer of formula (Ia), where R¹ is different from R². Yet, in other aspects, the monomer (I) is a monomer of a monomer of formula (Ib), where R¹═R². Also disclosed are aspects where the polymer comprises a monomer of formula (Ia) and a monomer of formula (Ib).

It is understood R¹ and/or R² can be any of the disclosed above groups. In some exemplary and unlimiting aspects, R¹ and/or R² can be one or more of —(CH₂)ₓO-alkyl, —(CH₂)ₓO(CH₂)ₓ(O)alkyl, —(CH₂)_{q}—CF₃, wherein x is 2-4, q is 1-4, and wherein alkyl can be substituted or unsubstituted as described above.

It is understood that various combinations of monomers can be present in the polymer. In some aspects, for example, when R¹ is different from R² and X is N-M¹, the polymer can comprise a monomer of formula (Ia-N-M¹):

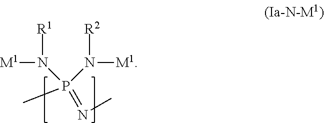

In yet in other exemplary aspects, when R¹ is the same as R² and X is N-M¹, the polymer can comprise a monomer of formula (Ib-N-M¹):

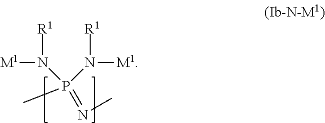

In still further aspects, both monomers of formula (Ia-N-M¹) and monomers of formula (Ib-N-M¹) can be present in the polymer. It is understood that any of the disclosed herein monomers can occur randomly in the polymer chain.

In still further exemplary aspects, when X=E and is O or S and when R¹ is different from R², the polymer can comprise a monomer having formula (Ia-E):

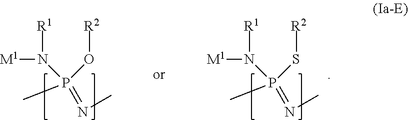

In still further exemplary aspects, when X=E and is O or S and when R¹ is the same as R², the polymer can comprise a monomer having formula (Ib-E).

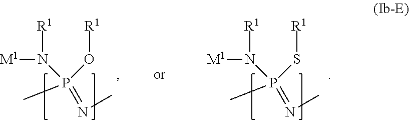

In still further aspects, the disclosed herein polymer can comprise monomers of formula (Ia-N-M¹) and formula (Ib-N-M¹); monomers of formula (Ia-N-M¹), formula (Ib-N-M¹), and formula (Ia-E); monomers of formula (Ia-N-M¹), formula (Ib-N-M¹), and formula (Ib-E); or monomers of formula (Ia-N-M¹), formula (Ib-N-M¹), formula (Ia-E), and formula (Ib-E). Again, it is understood that if any of the disclosed above monomers are present in the polymer, these monomers be randomly present in the polymer chain.

In still further aspects, the polymer can further comprise a monomer unit having formula (II):

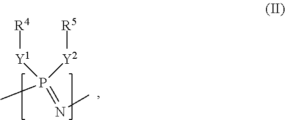

wherein R⁴ is selected from hydrogen, C₁₋₁₂ alkyl, C₁₋₁₂ heteroalkyl, —(C₀₋₅ alkyl-)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl);
R⁵ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl);
wherein R⁴ and R⁵ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁-13 heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl, and wherein Y¹ and Y² each is independently selected at each occurrence from O or S.

In still further aspects, Y¹═Y². In such exemplary and unlimiting aspects, Y¹ and Y² can be O. Yet in other aspects, Y¹ and Y² can be S. While also disclosed are aspects wherein Y¹ is X.

Also disclosed are aspects where the monomer (II) is a monomer having formula (IIa) where R⁴ is different from R⁵:

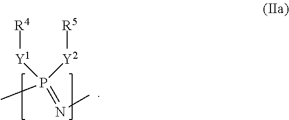

Also disclosed are aspects where the monomer (II) monomer having formula (IIb) where R⁴═R⁵.

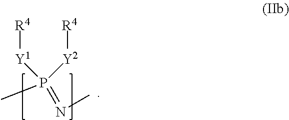

In still further aspects, any of the polymers disclosed herein can further comprise at least one monomer having formula (IIa) and at least one monomer having formula (IIb).

Also disclosed are aspects wherein the monomer of formula (IIa) and/or (IIb) are present, the polymer can also comprise a monomer having formula (Ic) wherein R² is R⁴.

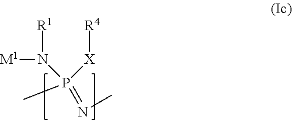

In some additional or alternative aspects, wherein the monomer of formula (IIa) and/or (IIb) are present, the polymer can also comprise a monomer having formula (Id) wherein R² is R⁵.

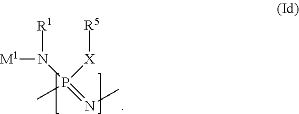

In still further aspects, when X is N-M¹, the polymer can comprise a monomer of formula (Ic-N-M¹) and/or (Id-N-M¹):

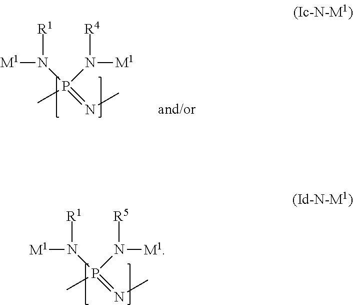

In some additional or alternative aspects, when X=E and is O or S, the polymer can comprise a monomer of formula (Ic-E) and/or (Id-E):

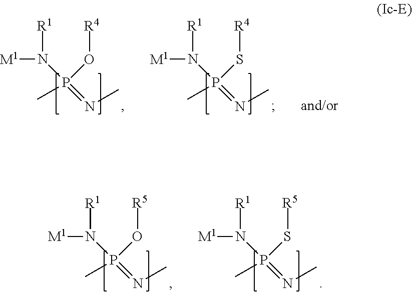

In still further aspects, it is understood that any of the disclosed herein monomers can be present in the polymer in any mole fraction. It is further understood that all the monomers can be randomly present in the polymer chain.

In still additional or alternative aspects, the polymer disclosed herein can comprise: monomers of formula (Ia-N-M¹) and formula (IIa); monomers of formula (Ia-N-M¹) and formula (IIb); monomers of formula (Ib-N-M¹) and formula (IIa); monomers of formula (Ib-N-M¹) and formula (IIb); monomers of formula (Ic-N-M¹) and formula (IIa); monomers of formula (Ic-N-M¹) and formula (IIb); monomers of formula (Id-N-M¹) and formula (IIa); monomers of formula (Id-N-M¹) and formula (IIb); monomers of formula (Ia-N-M¹), formula (Ib-N-M¹), formula (Ic-N-M¹); monomers of formula (Ia-N-M¹), formula (Ib-N-M¹), and formula (Id-N-M¹); monomers of formula (Ia-N-M¹), formula (Ib-N-M¹), formula (Ic-N-M¹), and formula (Id-N-M¹); monomers of formula (Ia-N-M¹), formula (Ib-N-M¹), formula (Ic-N-M¹), and formula (IIa); monomers of formula (Ia-N-M¹), formula (Ib-N-M¹), formula (Ic-N-M¹), and formula (IIb); monomers of formula (Ia-N-M¹), formula (Ib-N-M¹), formula (Ic-N-M¹), and formula (Id-N-M¹) and formula (IIa); and/or monomers of formula (Ia-N-M¹), formula (Ib-N-M¹), formula (Ic-N-M¹), and formula (Id-N-M¹) and formula (IIb).

In still further additional or alternative aspects, the polymer can comprise monomers of formula (Ia-E) and formula (IIa); monomers of formula (Ia-E) and formula (IIb); monomers of formula (Ib-E) and formula (IIa); monomers of formula (Ib-E) and formula (IIb); monomers of formula (Ic-E) and formula (IIa); monomers of formula (Ic-E) and formula (IIb); monomers of formula (Id-E) and formula (IIa); monomers of formula (Id-E) and formula (IIb); monomers of formula (Ia-E), formula (Ib-E), formula (Ic-E); monomers of formula (Ia-E), formula (Ib-E), and formula (Id-E); monomers of formula (Ia-E), formula (Ib-E), formula (Ic-E), and formula (Id-E); monomers of formula (Ia-E), formula (Ib-E), formula (Ic-E), and formula (IIa); monomers of formula (Ia-E), formula (Ib-E), formula (Id-E), and formula (IIa); monomers of formula (Ia-E), formula (Ib-E), formula (Ic-E), and formula (IIb); monomers of formula (Ia-E), formula (Ib-E), formula (Ic-E), and formula (IIb); monomers of formula (Ia-E), formula (Ib-E), formula (Ic-E¹), and formula (Id-E) and formula (IIa); and/or monomers of formula (Ia-E), formula (Ib-E), formula (Ic-E), and formula (Id-E) and formula (IIb).

It is further understood that any of the disclosed herein monomers in any combination can be present in the chain of the disclosed polymer.

In still further additional or alternative aspects, the polymer comprises formula (III):

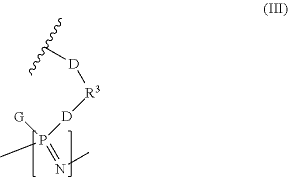

wherein a wavy line is a representative bond to a polymer chain, wherein G is R¹—N—, R²—X—, R⁴—Y—, or R⁵—Y—, D is O, S, N, R³ is a linking group selected from alkenylene, alkylene, arylene, wherein each of alkenylene, alkylene, arylene, is optionally substituted by with one or more of C₁₋₁₂ alkyl, C₁₋₁₂ alkoxy, C₁₋₁₂ heteroalkyl, —(C₀₋₅ alkyl-)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl.

In exemplary aspects, the polymer is not cross-linked. In still further aspects, the polymer is at least partially crosslinked. It is further understood that crosslinking can be achieved by any known in the art methods. In some aspects, the crosslinking can be covalent or ionic, or both. In some aspects, the crosslinking of the disclosed herein polymer can be achieved by adding a crosslinker during the polymerization process. In yet other aspects, crosslinking can be achieved by irradiation. In such aspects, irradiation can include IR, UV, or e-beam polymerization. In still further aspects, the crosslinking can be achieved by both adding the crosslinker and irradiating the formed polymer. In yet other aspects, crosslinking, if desired, can be achieved by a thermal initiation.

In some exemplary and unlimiting aspects, the polymer can comprise:

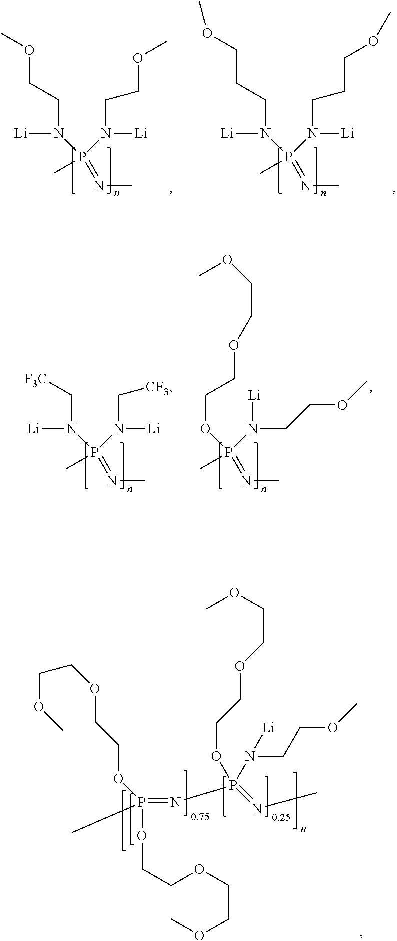

wherein n is greater than or equal to 2.

In some aspects, any of the polymers disclosed herein are conductive polymers. In such exemplary and unlimiting aspects, the polymer can exhibit conductivity of about 0.05 mS/cm to about 50 mS/cm, including exemplary values of about 0.1 mS/cm, about 0.5 mS/cm, about 1 mS/cm, about 2 mS/cm, about 5 mS/cm, about 8 mS/cm, about 10 mS/cm, about 15 mS/cm, about 20 mS/cm, about 25 mS/cm, about 30 mS/cm, about 35 mS/cm, about 40 mS/cm, and about 45 mS/cm at a temperature of about 20° C. to about 100° C., including exemplary values of about 25° C., about 30° C., about 35° C., about 40° C., about 45° C., about 50° C., about 55° C., about 60° C., about 65° C., about 70° C., about 75° C., about 80° C., about 85° C., about 90° C., and about 95° C.

In still further aspects disclosed herein is a polymer composition comprising any of the disclosed above polymers. In such aspects, the polymer composition can be a mixture (or a blend) of any of the disclosed herein polymers and one or more additional components. For example, in some aspects, the polymers disclosed herein can be mixed (blended) with various solvents to form a polymer composition. In yet other aspects, the polymers disclosed herein can be mixed (blended) with other polymers, binders, fillers, metal salts, and the like.

In some exemplary aspects, the polymer composition disclosed herein can comprise any of the disclosed above polymers and one or more of ethyl carbonate, propylene carbonate, PEGDME (polyethylene glycol dimethyl ether), tetraglyme, dibutyl phthalate (DBP), modified carbonate (MC3), polyethylene glycol (PEG), dimethyl phthalate (DMP), diethyl phthalate (DEP), dioctyl phthalate (DOP), cyclic phosphates (CP), succinonitrile (SN), ethyl propionate, ethyl acetate, dimethyl carbonate, ethyl methyl carbonate, diethyl carbonate, fluoroethylene carbonate, vinylene carbonate or any combination thereof.

In yet still further additional or alternative aspects, the polymer composition can further comprise one or more poly(ethyleneoxide) (PEO), polytetrafluoroethylene (PTFE), polyvinylidene fluoride (PVDF), polyvinylidene, fluoride-co-hexafluoropropylene (PVDF-HFP), polystyrene, (PS), polybutadiene (BR), polyvinylidene chloride (VDC), polymethyl methacrylate (PMMA), polyvinyl alcohol, (PVAL), polyvinyl acetate (PVA), polyphenylene oxide, (PPO), polyether ether ketone (PEEK), polyethylene terephthalate (PET), polybutylene terephthalate (PBT), polycarbonate (PC), polyether sulfone, polybenzimidazoles (PBI), polydimethylsiloxane, polyphenylene sulfide (PS), polypyrrole, polyphenylene, polyaniline, poly[bis(pentoxy)phosphazene], poly[bis(phenoxy)phosphazene], poly[(methoxyethoxyethoxy)(m-methyl phenoxy)phosphazene], or any combination thereof.

In still further additional or alternative aspects, the polymer composition can comprise a binder. Any known in the art binders can be used to achieve the desired result. For example, the binder can comprise polyethylene oxide (PEO), polyvinylidene fluoride binder (PVDF), cellulose, carboxymethylcellulose (CMC), polytetrafluoroethylene (PTFE), or any combination thereof. In still further exemplary aspects, the binder can also comprise polyethylene oxide (PEO), polyvinylidene fluoride (PVDF), polyvinylidene, fluoride-co-hexafluoropropylene (PVDF-HFP), polyvinyl acetate (PVA), styrene-butadiene resin (SBR), polyacrylic acid (PAA), polyetherimide (PEI), or any combination thereof.

In further additional or alternative aspects, the polymer composition can comprise a metal salt, wherein the metal in the metal salt comprises a cation selected from Li, Na, K, Al, Mg, Zn, Ca, or a combination thereof, and an anion comprising bistriflilmide (TFSI⁻), bis(fluorosulfonyl)imide) (FSI⁻), triflate (OTf⁻), hexafluorophosphate (PF₆⁻), hexafluroarsenate (AsF₆⁻), fluoride (F⁻), aluminum tetrachloride (AlCl₄⁻), boron tetrachloride (BCl₄⁻), boron tetrafluoride (BF₄⁻), iodide (I⁻), chloride (Cl⁻) chlorate (ClO₃⁻), bromide (Br⁻), bromate (BrO₃⁻), iodate (IO₃⁻), difluoro(oxalato)borate (DFOB⁻), bis(oxalato)borate (BOB⁻), difluorophosphate (DFP) or a combination thereof.

In still further aspects, the metal salts can be present in any amount suitable for the desired application. In some exemplary and unlimiting aspects, the metal salts can be present in an amount from 0 wt. % to about 70 wt. %, including exemplary values of about 0.01 wt. %, about 0.05 wt. %, about 0.1 wt. %, about 0.5 wt. %, about 1 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, and about 66.9 wt. % of the polymer composition. In still further aspects, the metal salts can be present in an amount from 0 wt. % to about 10 wt. %, including exemplary values of about 0.01 wt. %, about 0.05 wt. %, about 0.1 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, and about 10 wt. % of the polymer composition.

While in other aspects, the polymer composition can comprise a filler. In still further aspects, the polymer composition can comprise a ceramic additive. In some exemplary and unlimiting aspects, the ceramic additive comprises a plurality of nanoparticles, elongated nanoparticles, nanofibers, nanowires, nanowhiskers, or any combination thereof. In still further aspects, any ceramic additives known in the art and suitable for the desired purpose can be used. It is understood that the term “nano” refers to the particles/wires/fibers/whiskers/flake size (or minimal dimensions—e.g., diameter or thickness) of about 1 nm to about 500 nm, including exemplary values of about 5 nm, about 10 nm, about 20 nm, about 30 nm, about 50 nm, about 75 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, and about 475 nm.

In some exemplary and unlimiting aspects, the ceramic additive can comprise one or more of the following: lithium phosphorous oxynitride (LIPN), LiₓBO_{y}N_{z}, lithium lanthanum titanium oxide (LLTO), lithium aluminum titanium phosphate (LATP), lithium lanthanum zirconium oxide (LLZO), lithium sulfide-based compounds, perovskites, antiperovskite, montmorillonite, garnet, halide, argyrodite, various other lithium superionic conductors, or any combination thereof.

Some exemplary ceramic additives include, but are not limited to, the ceramic additive comprising of one or more of Li₂S·P₂S₅, Li₂S·SiS₂, Li₂S·SiS₂*LiₓMO₄, (where M is Si, P, or Ge), Li₂S·SiS₂·Li₃PO₄, Li₂S·SiS₂·xMS_{y} (wherein M is Sn, Ta, Ti), Li₂S·SiS₂—Li₃N, Li₃N·SiS₂, La_{2/3-x}Li₃ₓTiO₃, (0.03≤x≤0.167), La_{1/3-x}Li₃ₓTaO₃, (0≤x≤0.06), La_{1/3-x}Li₃ₓNbO₃, (0.03≤x≤0.167), La_{0.8}Sr_{0.2}Ga_{0.8}Mg_{0.2}O_{2.55}, Li_{0.33}La_{0.56}TiO₃, Li_{1.3}Ti_{1.7}Al_{0.3}(PO₄)₃, LiTiAl(PO₄)₃, LiAl_{0.4}Ge_{1.6}(PO₄)₃, Li_{1.4}Ti_{1.6}Y_{0.4}(PO₄)₃, Li₃₋₂ₓ(Sc₁₋ₓMₓ)₂ (PO₄)₃(x=0.1 or 0.2, M=Zr, Ti), Li₃Sc_{1.5}Fe_{0.5}(PO₄)₃, Li₂₊₂ₓZn₁₋ₓGeO₄, TiO₂, MgO, Mg(OH)₂, Al₂O₃, SiC₂, BaTiO₃, Li₂OHCl, Li₄(OH)₃C₁, Li₃N, Li₇La₃Zr₂O₁₂, Li₃YCl₆, Li₆PS₅Cl, or any combination thereof.

It is understood that all the additives present in the polymer composition can be in any desired range. In some aspects, any of the disclosed herein additives, independently and on each occasion, can be present in an amount of greater than 0 wt % based on the total weight of the polymer composition to less than 50 wt % based on the total weight of the polymer composition, including exemplary values of about 0.01 wt %, about 0.05 wt %, about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, about 15 wt %, about 20 wt %, about 25 wt %, about 30 wt %, about 35 wt %, about 40 wt %, about 45 wt %, about 50 wt %, based on the total weight of the polymer composition. In still further aspects, any of the disclosed herein additives, independently and on each occasion, can be present in an amount of greater than 0 wt % based on the total weight of the polymer composition to about 20 wt % based on the total weight of the polymer composition, including exemplary values of about 0.01 wt %, about 0.05 wt %, about 0.1 wt %, about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, and about 15 wt %.

In still further aspects, the polymers and polymer compositions disclosed herein exhibit an ion transference number of the cation of any of the disclosed above metal salts to be greater than about 0.4, or greater than about 0.45, or greater than about 0.5, or greater than about 0.6, or greater than about 0.7, or greater than about 0.8. For example, the ion transference number of the cation can be anywhere between about 0.4 to about 0.8, including exemplary values of about 0.42, about 0.45, about 0.47, about 0.5, about 0.52, about 0.55, about 0.57, about 0.6, about 0.62, about 0.65, about 0.67, about 0.7, about 0.72, about 0.75, and about 0.77. In still further aspects, the polymers and polymer compositions disclosed herein exhibit an ion transference number of the cation of any of the disclosed above metal salts of about 0.6 to about 0.8, including exemplary values of about 0.61, about 0.62, about 0.63, about 0.64, about 0.65, about 0.66, about 0.67. about 0.68, about 0.69, about 0.7, about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, about 0.90, about 0.91, about 0.92, about 0.93, about 0.94 and about 0.95. It is understood that the specific ion transference number will depend on the specific cation. For example, and without limitations, the polymer compositions disclosed herein should preferably exhibit Li-ion transference numbers from about 0.7 to about 0.9, including exemplary numbers of about 0.71, about 0.72, about 0.73, about 0.74, about 0.75, about 0.76, about 0.77, about 0.78, about 0.79, about 0.80, about 0.81, about 0.82, about 0.83, about 0.84, about 0.85, about 0.86, about 0.87, about 0.88, about 0.89, and about 0.90.

In still further aspects, the polymers and polymer compositions disclosed herein can be used as solid electrolytes, ionic conductors, actuators, sensors, capacitors, or a combination thereof.

In still further aspects, disclosed herein is a solid polymer electrolyte comprising any of the disclosed herein polymers or polymer compositions.

Also disclosed herein is a separator comprising any of the disclosed herein polymers or polymer compositions. It is understood that the disclosed herein polymers, polymer compositions, solid polymer electrolytes, and separators can be used in any energy source that fits the desired application. For example, the disclosed herein polymers, polymer compositions, solid polymer electrolytes, and separators can be used in batteries (including Li-ion and Li-metal batteries, Na-ion and Na metal batteries, K-ion and K-metal batteries, Al-ion and Al-metal batteries, Mg-ion and Mg metal batteries, Zn-ion and Zn metal batteries, and the like), supercapacitors, and hybrid electrochemical energy storage devices, to name a few.

In still further aspects, disclosed herein is a composition comprising a blend of any of the disclosed herein polymers or any of the disclosed above polymer compositions an electrode material. It is understood that such a composition can be directly used in any electrochemical cell.

In some aspects, the electrode material comprises intercalation-type cathode or intercalation-type anode material. In such aspects, the electrode material can be provided as a powder and can be milled or sized reduced by any known in the art methods prior to the blending (or mixing) with the disclosed herein polymers and/or polymer compositions. In still further aspects, the blends are substantially homogeneous. In yet still further aspects, the blends are homogeneous.

In still further aspects, the cathode material present in the composition can comprise (i) mixed metal phosphates or (ii) layered mixed metal oxide, or a combination thereof.

In some exemplary and unlimiting aspects, the cathode material can comprise lithium iron phosphate, lithium manganese iron phosphate, lithium vanadium phosphate, lithium manganese phosphate, lithium nickel cobalt manganese oxide, lithium nickel cobalt aluminum oxide, lithium cobalt oxide, and the like. It is understood that these cathode materials are only exemplary, and any known in the art cathode materials can be used. It is also understood that any of the disclosed herein cathode materials can be used as a blend with the disclosed herein polymers and/or polymer compositions, or they can be used as a separate electrode.

In further aspects, the anode material can comprise one or more of (i) natural or synthetic graphite; (ii) hard carbon; (iii) soft carbon; (iv) lithium titanate; (v) niobium titanium oxide or titanium niobium oxide; (vi) molybdenum niobium oxide; or any combination thereof. It is also understood that any of the disclosed herein anode materials can be used as a blend with the disclosed herein polymers and/or polymer compositions, or they can be used as a separate electrode.

In still further aspects, the electrode material comprises conversion-type cathode material. In such exemplary and unlimiting aspects, the cathode material can comprise a sulfur (S)-based composite. For example and without limitations, such cathode materials can comprise Li₂S or Li₂S-comprising composite, Li₂S—Li₂Se or Li₂S—Li₂Se-comprising composite, or any combination thereof.

In still further aspects, any of the disclosed herein polymer compositions can comprise a filer. In still further aspects, the compositions disclosed herein can comprise a filler. In some exemplary and unlimiting aspects, the filler can be a conductive material. For example and without limitations, the filler can comprise carbon, carbon black, modified carbon, modified carbon black, graphene, graphene oxide, graphite, exfoliated graphite, carbon nanotubes, carbon nanofibers, carbon fibers, carbon nano-flakes, graphite ribbons, or any combination thereof.

The compositions can further comprise a binder comprising polyvinylidene fluoride (PVDF), polyvinylidene, fluoride-co-hexafluoropropylene (PVDF-HFP), polyvinyl acetate (PVA), carboxymethyl cellulose (CMC), and polyetherimide (PEI). In still further exemplary aspects, the binder can also comprise polyethylene oxide (PEO), polyvinylidene fluoride (PVDF), polyvinylidene, fluoride-co-hexafluoropropylene (PVDF-HFP), polyvinyl acetate (PVA), styrene-butadiene resin (SBR), polyacrylic acid (PAA), polyetherimide (PEI), or any combination thereof.

In certain aspects, the electrode material can be provided as a slurry prior to the mixing with the disclosed herein polymers or polymers compositions. It is understood that any known in the art solvents can be used. Some examples of solvents include, but are not limited to N-methyl pyrrolidone, water, acetonitrile, dimethylsulfoxide, and tetrahydrofurane. In still further aspects, the composition can be deposited on a current collector. In still further aspects, the compositions disclosed herein can be used in an electrochemical cell.

In still further aspects, the polymers, polymer compositions and compositions comprising the same are flame resistant.

In other aspects, the polymers and polymer compositions disclosed herein can be used as solid electrolytes, as binders for commercially available electrode materials, and as ionically conducting separator materials. In still further aspects, the polymers and polymer compositions disclosed herein inhibit dendrite formation in lithium (potassium or sodium) metal batteries. In still further aspects, the polymers and polymer compositions disclosed herein can serve as an all-in-one binder, electrolyte, and ionically conductive separator.

### Batteries

Also disclosed herein are electrochemical cells. In still further aspects, the electrochemical cell is a battery.

In certain aspects, disclosed herein is a battery comprising an anode material; a cathode material; and an electrolyte comprising from greater than 0 wt. % to 100% of the disclosed herein the polymer and/or polymer composition.

In certain aspects, the electrolyte is any of the disclosed herein polymers or polymer compositions.

In still further aspects, the anode material can be blended together (or intermixed together) with the polymer electrolyte. Yet, in other aspects, the anode material is not blended with the electrolyte.

In some aspects, the cathode material can be blended together (or intermixed together) with the polymer electrolyte. Yet, in other aspects, the cathode material is not blended with the electrolyte.

In aspects wherein the cathode material or the anode material is preblended with the disclosed herein electrolyte, the blend can be disposed on current collectors at each side of the battery. Any known in the art, current collectors can be utilized. In some aspects, the current collectors can comprise aluminum, copper, titanium, carbon, nickel, various alloys comprising these or other metals or any combination thereof. It is understood that the current collector can be a wire, a mesh, a foam, a foil, a porous foil, coated foil, and the like.

In still further aspects, the electrolyte can comprise of any of the disclosed herein polymers or polymer compositions, about 0.1 to about 10.0 wt %, including exemplary values of about 0.5 wt %, about 1 wt %, about 2 wt %, about 3 wt %, about 4 wt %, about 5 wt %, about 6 wt %, about 7 wt %, about 8 wt %, and about 9 wt % of an organic solvent and a suitable amount of inorganic salt (typically, from about 0.1 wt % to about 20 wt %, including exemplary values of about 0.5 wt %, about 1 wt %, about 2 wt %, about 5 wt %, about 7 wt %, about 10 wt %, about 12 wt %, about 15 wt %, and about 18 wt %). In such exemplary aspects, any of the known in the art and suitable for the desired application solvents can be used. In certain aspects, the solvent can comprise dioxane, ethylene carbonate, dimethyl carbonate, diethyl carbonate, ethyl methyl carbonate, polyoxylene, fluoroethylene carbonate, propylene carbonate, N-methyl acetamide, acetonitrile, symmetric sulfone, sulfolane, polyethylene glycol, dimethoxyethane, 1,3-dioxolane, glymes, siloxane, ethylene oxide grafted sulfolane, or a combination thereof.

In still further aspects, the electrolyte can comprise the disclosed herein polymers and polymer compositions as additives. In such aspects, the electrolyte can comprise any of the disclosed above organic solvents, any of the disclosed above inorganic (metal) salts and about 0.1 to about 10 wt % of the disclosed herein polymer or polymer composition based on the total weight of the electrolyte. In such aspects, the polymer (or the polymer composition) can be present in an amount of about 0.1 to about 2.5 wt %, including exemplary values of about 0.5 wt %, about 1 wt %, about 1.5 wt %, about 2.0 wt %, about 2.5 wt %, about 3 wt %, about 3.5 wt %, about 4.0 wt %, 4.5 wt %, about 5 wt %, about 5.5 wt %, about 6.0 wt %, about 6.5 wt %, about 7 wt %, about 7.5 wt %, about 8.0 wt %, 8.5 wt %, about 9 wt %, about 9.5 wt %.

Yet in other aspects, the inorganic (metal) salt can comprise a potassium, sodium, lithium, magnesium, calcium, zinc, or aluminum salt of bis(fluorosulfonyl) imide, perchlorate, tetrafluoroborate, hexafluorophosphate, hexafluroarsenate, or a potassium, sodium, or lithium salt of aluminum tetrachloride, boron tetrachloride iodide, chlorate, borate, iodate, or a combination thereof.

In further aspects, the cathode material (either blended with the electrolyte or used separately) can comprise one or more of layered metal oxide cathodes, vanadium-based cathode, sulfur-based cathode, manganese-based cathode, lithium-rich cathode, NMC (lithium nickel-manganese-cobalt oxide) cathode, NCA (lithium nickel-cobalt-aluminum oxide) cathode, NFM (lithium nickel-iron-manganese oxide) cathode, LCO (lithium-cobalt oxide) cathode, LFP (lithium iron phosphate) cathode, sulfur or selenium cathode, lithium sulfide or lithium selenide cathode, spinels cathode, olivines cathode, or any combination thereof. The cathode materials disclosed herein can also be used in a blend with the polymers and polymer compositions described herein.

In further aspects, the anode material (either blended with the electrolyte or used separately) can comprise one, two or more of the following elements: carbon, silicon, tin, antimony, lithium, sodium, potassium, zinc, nickel, copper, aluminum, silicon oxides, magnesium, lithium alloys, lithium intermetallics, lithium compounds, sodium alloys, sodium intermetallics, sodium compounds, potassium alloys, potassium intermetallics, potassium compounds or any combination thereof. The anode materials disclosed herein can also be used in a blend with the polymers and polymer compositions described herein.

In still further aspects, the batteries disclosed herein can comprise a separator. In certain aspects, any known in the art and suitable for the desired application separators can be used. In yet other aspects, the separators can comprise any of the disclosed herein polymers and/or polymer compositions.

In still further aspects, the batteries disclosed herein exhibit a capacity retention of at least about 80%, at least about 82%, at least about 85%, at least about 87%, at least about 90%, at least about 92%, or at least about 95%, over at least about 250 cycles, over at least about 300 cycles, over at least about 350 cycles, over at least about 400 cycles, over at least about 450 cycles, or even over at least about 500 cycles when operated at a temperature from about 20° C. to about 60° C., including exemplary values of about 25° C., about 30° C., about 35° C., about 40° C., about 45° C., about 50° C., and about 55° C.

In still further aspects, the batteries disclosed herein can exhibit a Coulombic efficiency (after the initial 1-5 “formation” cycles) of greater than about 90%, greater than about 91%, greater than about 92%, greater than about 93%, greater than about 94%, greater than about 95%, greater than about 96%, greater than about 97%, greater than about 98%, greater than about 99%, greater than about 99.1%, greater than about 99.2%, greater than about 99.3%, greater than about 99.4%, greater than about 99.5%, greater than about 99.6%, greater than about 99.7%, greater than about 99.8%, or greater than about 99.9% or greater than about 99.99% for at least about 250 cycles, at least about 300 cycles, at least about 350 cycles, at least about 400 cycles, at least about 450 cycles, or at least about 500 cycles, at 0.05C to 0.2C charge-discharge rates.

In still further aspects, the battery disclosed herein is capable of operating in a temperature range from about 60° C. to about 100° C., including exemplary values of about 65° C., about 70° C., about 75° C., about 80° C., about 85° C., about 90° C., and about 95° C.

In still further aspects, the batteries disclosed herein are rechargeable.

In yet further aspects, the cell is substantially stable for about 100 to about 500 plating/stripping cycles at an operating temperature.

In still further aspects, the solid electrolytes formed from the disclosed herein polymers and polymer compositions can have a thickness from about 10 nm to about 1 mm, including exemplary values of about 15 nm, about 20 nm, about 50 nm, about 100 nm, about 250 nm, about 500 nm, about 750 nm, about 1 μm, about 5 μm, about 10 μm, about 15 μm, about 20 μm, about 25 μm, about 50 μm, about 75 μm, about 100 μm, about 250 μm, about 500 μm, about 750 μm, and about 990 μm.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, air taxi, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500 batteries of the present disclosure. Batteries in multi-cell batteries may be arranged in parallel or in series.

In still further aspects, the electrode materials in the disclosed herein batteries are substantially dendrites free.

### Methods

Further disclosed herein are methods of making of the disclosed herein polymers, polymer compositions, compositions, and batteries. In some aspects, the methods comprise: combining a polymer having formula (IV)

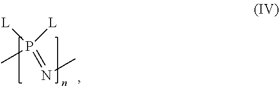

wherein L is a leaving group selected from halo, or OSO₃R, wherein R is —CH₃, —CF₃, —CH₂CH₃, aryl, alkyl, haloalkyl, wherein R is optionally substituted; and wherein n is greater or equal to 2, with a compound having formula R¹—NH-M^{a} to form a polymer having formula (V)

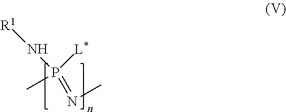

wherein L* is L or R¹—N-M^{a}, wherein M^{a} is H or Li, Na, or K, and wherein n is greater or equal to 2.

In certain exemplary and unlimiting aspects, R can be —CH₃, —CF₃, —CH₂CH₃,

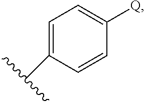

wherein Q is CF₃, NO₂, F, or CH₃.

In still further aspects, L*is R¹—(NM^{a})-.

In some aspects, the methods further comprise combining with a compound having formula M^{b}-X′—R² to provide a polymer comprising a monomer of formula (VI)

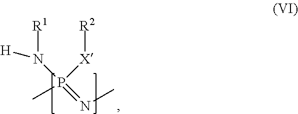

wherein X′ is O, S, or N-M^{b}, wherein M^{b} is H or Li, Na, or K.

Yet in other aspects, X′ is O or S. While in still further aspects, X′ is N—H.

In some aspects, R¹ is different from R².

Yet in still further aspects, R¹—NH-M^{a} and R²—X-M^{b} are combined with the polymer comprising monomers (V)simultaneously. While in other aspects, the polymer comprising monomers (V) is combined first with R¹—NH-M^{a} and then with R²—X-M^{b}.

In some additional or alternative aspects, the methods comprise further combining with a compound having formula M^{c}Y—R⁴, wherein M^{c} is Li, Na, K, or H, and wherein Y is O or S.

In some additional or alternative aspects, the methods comprise further combining with a compound having formula M^{c}Y—R⁵, wherein R⁵ is different from R⁴.

In some additional or alternative aspects, the methods comprise combining with a compound having a formula M^{d}-D-R³-D-M^{d}, wherein D is O, S, N—H, wherein M^{d} is H, Li, Na, or K, and R³ is a linking group selected from alkenylene, alkylene, arylene, wherein each of alkenylene, alkylene, arylene, is optionally substituted by with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁-13 heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl.

In some additional or alternative aspects, the methods further comprise reacting with M¹-Z: wherein M¹ is Li, Na, or K, and wherein Z is alkyl, aryl, silazane, or dialkylamino. In yet still further exemplary and unlimiting aspects, M¹-Z comprises n-butyllithium (n-BuLi), sec-butyllithium (sec-BuLi), tert-butyllithium, methyllithium, lithium disiopropylamide (LDA), lithium bis(trimethylsilyl)amide, lithium hexamethyldisilazide (LiHMDS), or any combination thereof.

Some exemplary methods are discussed below and also discussed further in the Exemplary section.

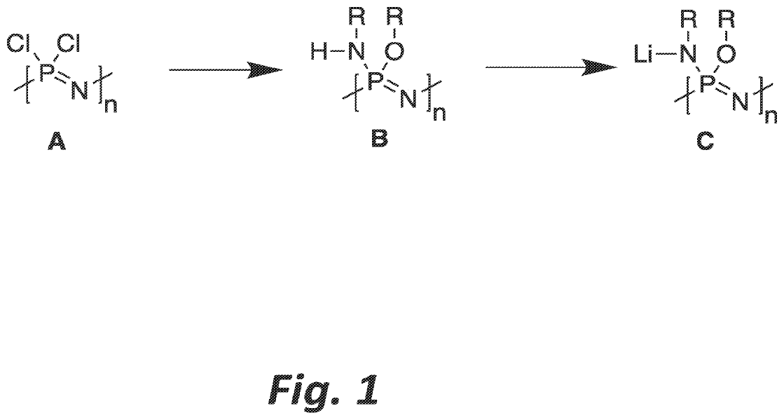

Here a poly(dichloro)phosphazene is used as an exemplary precursor for the synthesis of a range of lithiated poly(amido-phosphazene)s with N-Li+ ion pairs creating Li+-dissociable groups for charge transfer (FIG. 1). The advantage of polyphosphazenes is provided by the synthetic flexibility of this chemistry, as hundreds of polymers can be easily synthesized via a facile nucleophilic substitution reaction. Additionally, polyphosphazenes may be completely amorphous with T_{g} as low as −80° C. due to the inherent flexibility of the P═N backbone, which makes them advantageous for battery applications as solid-polymer electrolytes. Control of the synthesis conditions, molecular weight, and polydispersity index of poly(dichloro)phosphazene is needed for the use of these molecules. There are two available synthesis routes to poly(dichloro)phosphazene, which involve thermal ring-opening polymerization and living cationic polymerization.

The use of thermal ring-opening polymerization allows the synthesis of high molecular weight polymers, which is achieved using high-temperature reaction conditions (>250° C.) with little control on the polydispersity index (PDI). Another key advantage of thermal ring-opening polymerization is the accessibility of the hexachlorophosphazene and facile purification conditions. Although living cationic polymerization requires low reaction temperature and can give higher yields, it gives lower MW and requires tedious purification procedures.

The mechanism of the thermal ring-opening polymerization is as follows. At reduced pressure and sufficiently high temperature (˜250° C.), chlorine atoms are cleaved from [NPCl₂]₃ to give a cationic phosphazenium species, which initiates the ring opening of a second ring, thus propagating the polymerization. Thus, Cl cleavage is unlikely at temperatures less than 250° C. It is understood, however, the hexachlorophosphazene monomer needs to be substantially pure or pure. Without wishing to be bound by any theory, it is understood that small amounts of impurities or moisture can promote crosslinking.

In some implementations, catalysis using Lewis acids, such as AlCl₃ and BCl₃, can enable higher yield while lowering the rate of the formation of cross-linked products. The mechanism of the thermal ring-opening polymerization in the presence of AlCl₃ is different from the non-catalytic route and involves the facile generation of electrophilic phosphazenium species as well as facile termination of the polymer chain growth, which is often accompanied by the formation of low MW.

The composition of the side chain plays a role in the contribution to polyphosphazene's mobility, amorphous/crystalline phases distribution, and solvation of Li— ions. The reported high ionic conductivity of polyphosphazene derivatives of the dual-conducting nature is due to the interaction of Lewis acid groups in the —N═P— side chains with Li-ion. For example, the derivatives of 2-methoxy-2-ethoxy-2-ethoxy-phosphazene or MEEP have been widely explored with a range of Li-salts as polyphosphazene-based dual-ion conductors with a range of conductivity levels 10⁴-10⁻⁵ S cm⁻¹ at RT. Unfortunately, these materials lack the advantage of facile functionalization. Therefore, the synthesis of single Li-ion conducting polyphosphazenes utilizing oxy-derivatives of poly(organo)phosphazenes is largely inconvenient.

Facile functionalization strategy of poly(dichloro)phosphazenes by versatile O— and N— terminated nucleophiles have been demonstrated in prior research. The formation of P— NH—R bond at the —NP— side chain (e.g., in poly(amido)phosphazene) warrants subsequent facile lithiation of the nitrogen atom with the formation of Li salts. For example, and as disclosed herein, a substitution at the PCl₂ center by a range of aliphatic, aromatic, heteroaromatic, cyclic amines can lead to symmetrical or mixed poly(amido)phosphazenes (FIG. 1B). Additionally, a substitution at the PCl₂ center by a range of aliphatic, aromatic, heteroamatic, cyclic amines or a range of aliphatic, aromatic alcohols or thiols can lead to mixed poly(organo)phosphazenes with amido, oxy, thiol functionalities (FIG. 1B). The possibility of further NH functionalization in the alpha-position to the polymer N═P backbone may be envisioned to offer a route to forming N—Li salts with fixed anion groups (FIG. 1C), and that has not been reported to the inventors' knowledge.

A polymer electrolyte also serves the role of separator, which needs to meet several important criteria to become a viable candidate for use in Li-ion batteries. The most critical properties can be broadly categorized as the following: (i) good physical/mechanical properties (such as sufficiently high tensile strength and hardness); (ii) good thermal properties; (iii) good electrochemical properties (such as high ionic conductivity, high-rate capability, sufficient stability on the anode and cathode, etc.).

Unfortunately, previously described works on polyphosphazene-based solid polymer electrolytes (SPEs) failed to attain adequate performance characteristics for use in fully functional Li-ion batteries. As such, there remains a need for the development of improved polyphosphazene-based SPEs and novel methods of their manufacturing and use in rechargeable Li-ion and Li-metal batteries.

Lithiated polyphosphazenes single Li-ion conducting SPEs are disclosed in this work. Such SPEs are formed from the corresponding amido derivatives by the lithiation reaction by substituting the proton of the amido group with the Li-ion. A range of functional groups on the polymer's backbone may be advantageous for facile lithiation. Such SPEs may exhibit a Li-ion transference number close to unity and can warrant necessary stability of cell performance, including minimized polarization, minimized anode parasitic side reactions, minimized decomposition of mobile anionic species, low internal impedance, reduced diffusion resistance and improved fast charge. Moreover, their polymeric nature may exhibit more attractive processing characteristics than common ceramic materials. Additionally, a range of functional groups on the polymer's backbone or a side chain can render attractive wetting characteristics on the surface of ceramic electrode materials, thus lowering internal cell impedance and increasing Li— ion conductivity at the interface.

In addition, the ability of such SPEs to impede heat evolution and scavenge radicals is another attractive feature that renders cell safety and high-temperature performance characteristics. Moreover, the mechanical properties of the disclosed SPEs can be tuned by introducing a range of functional groups. For example, oligoether groups can render lithiated polyphosphazenes with necessary liquid-like behavior and reduce the stiffness of the backbone using decreased glass transition temperature.

This disclosure describes the substantially precise tailoring of the structure and composition of lithiated poly(amido)phosphazenes that may achieve high ionic conductivities (>10⁻³ S cm⁻¹), high voltage stabilities (>4.0 V vs. Li/Li⁺), conformal interface with active materials, low internal impedance, and long cycle life.

This disclosure describes the structure, composition and methods of manufacturing lithiated polyphosphazenes of general formula 3 or —(N═P(R¹N—Li)(R²N—Li))ₙ— where n is >2, and where R¹ and R² can independently at each occasion selected from the groups disclosed above. Yet in some implementations, R¹ and R² can be for example, but not limited to, CH₃O—CH₂—CH₂—, CH₃O—CH₂—CH₂—CH₂—, CH₃O—CH₂—CH₂—O—CH₂—CH₂, CH₃O—CH₂—CH₂—(O—CH₂—CH₂)ₙ— where n=2-10, fluorinated alkyl, such as CF₃—CH₂—, FSO₂—, CF₃— SO₂—. In some implementations, lithiated polyphosphazenes of such a general formula may be partially cross-linked. In other implementations, such lithiated polyphosphazenes may be non-cross-linked.

The disclosure describes the structures, compositions and methods of manufacturing of lithiated polyphosphazenes of general formula 5 or —([N═P(R¹N—Li)(R²N—Li)]ₓ—([N=P(R⁴X)(R⁴X)]₁₋ₓ)ₙ—, where n is ≥2, where x≥0.0010 and <1, and where R¹, R², and R⁴ can be independently selected at each occasion from any groups shown above. In some implementations, R¹, R², and R⁴ can be independently selected at each occasion from, for example, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where X is O, S. In another aspect, lithiated polyphosphazenes of general formula 5 can be cross-linked or non-cross-linked.

The disclosure also describes the structures, compositions and methods of manufacture of lithiated polyphosphazenes of general formula 7 or —([N═P(R¹N—Li)(R⁴X)]ₓ— ([N═P(R⁴X)(R⁴X)]₁₋ₓ)ₙ—, where n is >2, where x>0 and <1, and where R¹ and R⁴ can be independently selected at each occasion from any groups shown above. In some implementations, R¹ and R⁴ can be independently selected at each occasion from, for example, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where X is O, S. In some aspects, lithiated polyphosphazenes of this general formula 7 may be cross-linked or non-cross-linked.

In some implementations, it may be advantageous to tune and precisely control the synthesis conditions, molecular weight, and polydispersity index of poly(dichlorophosphazene) 1 to attain the most desirable SPE properties.

In some implementations, it may be advantageous for the starting poly(dichlorophosphazene) 1 to be prepared using a thermal ring-opening polymerization reaction. In some other implementations, it may be advantageous for the poly(dichlorophosphazene) 1 to be prepared using living cationic polymerization.

It may be preferable that thermal ring-opening polymerization is achieved at high-temperature reaction conditions (e.g., above around 250° C.). In some implementations, it may be preferable that thermal ring-opening polymerization is achieved at around 265°±10° C. reaction conditions.

In some implementations, to synthesize poly(dichloro)phosphazene 1, the hexachlorocyclotriphosphazene monomer with minimal to substantially no impurities is used. In some implementations, the fraction of impurities is kept below about 1 wt. % (for example, it can be kept below about 0.9 wt,%, about 0.8 wt. %, about 0.7 wt. %, about 0.6 wt,%, about 0.5 wt. %, about 0.4 wt. %, about 0.3 wt. %, about 0.2 wt. %, about 0.1 wt. %, or about 0.05 wt. %). Examples of purification methods of hexachlorophosphazene may include but are not limited to the recrystallization from a solvent, such as hexane, acetone, benzene, or toluene.

In some implementations, to synthesize poly(dichloro)phosphazene 1, the degree of cross-linking needs to be controlled. The inventors found that reducing the presence of trace amounts of water substantially reduces the formation of the cross-linked product. The inventors also found that successful synthesis conditions of poly(dichloro)phosphazene 1 included specific heating time. For example, the thermal ring-opening polymerization can be achieved within about 3 to about 9 hours (including exemplary values of about 4 h, about 4.5 h, about 5 h, about 5.5 h, about 6h, about 6.5 h, about 7h, about 7.5 h, about 8h, and about 8.5 h). In yet other implementations, the thermal ring-opening polymerization can be achieved implementations within about 4 to about 6 hours (including exemplary values of about 4.2 h, about 4.5 h, about 4.8 h, about 5. h, about 5.2 h, about 5.5 h, and about 5.8h).

In some implementations, to synthesize poly(dichloro)phosphazene 1, one can use a Lewis acid catalyst, such as AlCl₃ and BCl₃, to increase the reaction product yield and to lower the rate of cross-linked product formation.

However, it is understood that in some implementations, some cross-linking may be practically unavoidable at high temperatures. However, the presence of cross-linking in 1 may enhance the mechanical properties of the polyphosphazenes, which may be advantageous for some implementations.

In some implementations, poly(dichlorophosphazene) 1 can be purified to remove the cross-linked product(s). For example, the dissolution of the reaction mixture into dichloromethane and subsequent precipitation of 1 by adding hexane may be utilized to achieve desired high purity of polymer 1.

The disclosure also describes the structure, composition and methods of manufacturing functionalized amido-substituted polyphosphazenes of general formula 2. In some implementations, a method may entail reacting poly(dichlorophosphazene) 1 of a formula —(N=P(Cl)(Cl))ₙ—, where n≥2 with amino derivatives R¹—NH₂ or R²—NH₂, where R¹ and R² are independently at each occasion selected from any of the described groups. In some exemplary and unlimiting aspects, R¹ and R² can independently be CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—.

The disclosure also describes the structure, composition, and methods of manufacturing functionalized amido substituted polyphosphazenes of general formula 4. In some exemplary and unlimiting aspects, a suitable method may entail reacting poly(dichlorophosphazene) 1 of a formula —(N=P(Cl)(Cl))ₙ—, where n>2 with amino derivative R¹—NH₂ and R⁴—X—H, where R¹ and R⁴ are independently at each occasion selected from any of the described groups. In some exemplary and unlimiting aspects, R¹ and R⁴ can independently be CH₃O—CH₂—CH₂—, CH₃O—CH₂—CH₂—CH₂—, CH₃O—CH₂—CH₂—OCH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where X is O, S.

In some implementations, a suitable method of manufacture of amido substituted polyphosphazenes of a general formula 4 may entail reacting poly(dichlorophosphazene) 1 of a formula —(N=P(Cl)(Cl))ₙ—, where n>2 with amino derivative R²—NH₂ and R⁴—X—H, where R² and R⁴ are independently at each occasion selected from any of the described groups. In some exemplary and unlimiting aspects, R² and R⁴ independently can be CH₃O—CH₂—CH₂—, CH₃O—CH₂—CH₂—CH₂—, CH₃O—CH₂—OH₂—O—OH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where X is O, S.

In some implementations, a suitable method of manufacture of amido substituted polyphosphazenes of a general formula 4 may entail reacting poly(dichlorophosphazene) 1 of a formula —(N=P(Cl)(Cl))ₙ—, where n>2 with amino derivatives R¹—NH₂, R²—NH₂ and R⁴—X—H, where R¹, R², and R⁴ are independently at each occasion selected from any of the described groups. In some exemplary and unlimiting aspects, R¹, R² and R⁴ independently can be CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂, CF₃—SO₂—, and where X is O, S.

The disclosure also describes the structure, composition, and methods of manufacturing amido substituted polyphosphazenes of general formula 6. The suitable method may entail reacting poly(dichlorophosphazene) 1 of a formula —(N=P(Cl)(Cl))ₙ—, where n>2 with amino derivative R¹—NH₂ and R⁴—X—H, where R¹ and R⁴ are independently at each occasion selected from any of the described groups. In some exemplary and unlimiting aspects, R¹ and R⁴ can independently be, for example, but are not limited to, CH₃O—CH₂—CH₂—, CH₃O—CH₂—CH—CH, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where X is O, S.

It is appreciated that in some implementations, the reactions with the formation of polyphosphazenes of the general formula 2 and 4 may proceed either by the simultaneous addition of PW—NH₂ and R²—NH₂ or by their stepwise addition. It is also appreciated that amido- groups of a general formula —NHR with steric bulk may be introduced first to facilitate further substitution at the PCI center in 1 by a less bulky group to increase the final yield of the product. Similarly, the oxy- or thio-substituents of the general formula R⁴—XH (with or without the steric bulk) may be first introduced to the P center, followed by the substitution by the low steric bulk amido ligands. Examples of steric bulk groups may include but are not limited to trifluoroethoxy, trifluoromethylsulfonyl, fluorosufonyl, iso-propoxy, isobutoxy, tert-butoxy, or phenyl.

In some implementations, the amines of the general formula R¹—NH₂ and R²—NH₂ may be introduced to the P-center of 1 based on their basicity. In some implementations, amines with less basic properties may preferably be introduced first, followed by amines with more basic properties. Examples of amines with basic properties may include but are not limited to 2-methoxy-ethylamine, 2-methoxypropylamine, or 2,2,2-trifluoroethylamine.

Some of the classes of polyphosphazenes may exhibit poor dimensional stability, which renders their liquid-like behavior. This results in the facile formation at the surface of electrodes. Therefore, in some implementations, the side chains in lithiated polyphosphazenes may be effectively utilized to increase dimensional stability. As an example, a long chain group or cross-linking may be used for this purpose. Examples of such groups may include but are not limited to oligoethers, such as oligo ethylene glycol.

In some implementations, the substitution reactions with the formation of polyphosphazenes of general formula 2, 4, and 6 may preferably be performed in the presence of basic non-nucleophilic amines to capture the generated hydrochloric acid. It is also important to recognize that polyphosphazenes 2, 4, and 6 exhibit significant basicity due to the presence of the —N=P(NR¹H)— and —N=P(NR²H)— groups. Therefore, the resulting hydrochloric acid may be trapped by the amido groups of amido-functionalized polyphosphazenes. In some implementations, it can be possible to use high-basicity amines, such as triethylamine, pyridine, dimethylaminopyridine, or diazabicycloundecene, to ensure complete removal or hydrochlorides from the polymers. In some implementations, mechanical agitation or stirring of the reaction solution can be provided to avoid trapping hydrochloric acid residues in the polymer chain.

In another aspect, the disclosure relates to the structure and synthesis of poly(amido)phosphazenes of general formula 2 with R¹—NH₂ and R²—NH₂ or mixtures thereof in the presence of a base, such as, but not limited to, triethylamine, pyridine, dimethylaminopyridine, diazabicycloundecene.

In another aspect, the disclosure relates to the structure and synthesis of poly(amido)phosphazenes of general formula 4 with R¹—NH₂ or R²—NH₂, and R⁴—X—H, or mixtures thereof in the presence of a base, such as triethylamine, pyridine, dimethylaminopyridine, diazabicycloundecene.

In another aspect, the invention relates to the structure and synthesis of poly(amido)phosphazenes of general formula 6 with R¹—NH₂ and R⁴—X—H in the presence of a base, such as triethylamine, pyridine, dimethylaminopyridine, diazabicycloundecene.

Regarding the purification of polyphosphazenes of general formula 2, 4, and 6, in some implementations, dialysis using pores sizes with MW limit−2 kDa in over a range of polar solvents may be advantageously implemented to purify resulting polymers from small molecules, oligomeric molecules and the hydrochloric acid salts of amines. Illustrative examples of such solvents may include tetrahydrofurane, water, methanol, chloroform, and dimethylsulfoxide. In some implementations, dialysis using a media with controlled pore sizes may be used to purify the resulting polymers from the small MW impurities or other macromolecular impurities. In some aspects, further purification may be accomplished by precipitation of polyphosphazenes of general formula 2, 4, and 6 from solutions using adding suitable non-polar solvents. Illustrative examples of suitable solvents may include ether, hexane, heptane, and acetone. Note that in some implementations, a subsequent drying of the polymers in a vacuum may be needed to ensure the complete evaporation of all organic volatiles.

The disclosure also relates to the polymer materials of the general formula 2, 4, and 6 (e.g., poly(amidophosphazene) featuring —NH—R¹ or —NH—R² bonds in the alpha position at the —NP— backbone. In some implementations, it may be highly advantageous to convert the —NH—R¹— or —NH—R² groups in the alpha position at the —NP— backbone to the corresponding lithium salts featuring —(N—Li)—R¹— or —(N—Li)—R²-groups. The inventors successfully achieved lithiation of the nitrogen atom, leading to the formation of the N—Li salts of the general formulas 3, 5, and 7.

Unlike many other reported synthesis methods of single Li-ion conducting polymers, direct lithiation of the NH-groups in poly(amidophosphazenes) has never been reported or proposed. The inventors found the above-described method effective, convenient and versatile as it enables controllable conformations and the stereochemistry at the P═N center. In some implementations, the lithiation reactions may be performed using routine synthesis protocols under an inert atmosphere and inert solvents. It is important to recognize that in some implementations, the exchanging of a proton by lithium may advantageously be undertaken at relatively low temperatures (from −80 to 0° C.) to avoid any side reactions, Illustrative examples of suitable lithium organometallic compounds that may be used for the lithiation step include but are not limited to n-butyllithium (n-BuLi), sec-butyllithium (sec-BuLi), tert-butyllithium, methyllithium, lithium disiopropylamide (LDA), lithium bis(trimethylsilyl)amide, lithium hexamethyldisilazide (LiHMDS).

This disclosure also relates to the microstructure and the synthesis of lithiated poly(amidophosphazenes) of a general formula 3, which in some implementations comprises a reaction of derivatives 2 with lithium organics of the general formula Z—Li, where Z is alkyl, such as methyl, n-butyl, aryl, such as phenyl, alkylamino, such as ((CH₃)₂CH)₂N—, silazane, such as ((CH₃)₃Si)₂N—, among others.

In another aspect, the disclosure relates to microstructure and the synthesis of lithiated poly(amidophosphazenes) of a general formula 5, which can comprise a reaction of derivatives 4 with lithium organics of the general formula Z—Li, where Z is alkyl, such as methyl, n-butyl, aryl, such as phenyl, alkylamino, such as ((CH₃)₂CH)₂N—, and silazane, such as ((CH₃)₃Si)₂N—.

This disclosure relates to the microstructure and the synthesis of lithiated poly(amidophosphazenes) of a general formula 7, which can comprise the reaction of derivatives 6 with lithium organics of the general formula Z—Li, where Z is alkyl, such as methyl, n-butyl, aryl, such as phenyl, alkylamino, such as ((CH₃)₂CH)₂N—, silazane, such as ((CH₃)₃Si)₂N—.

It is essential to recognize that organolithium reagents may be used in amounts that are stoichiometric to the total NH groups in polymers of general formulas 2, 4, and 6. In some implementations, the resulting alkane or amine may be easily removed by vacuum distillation or a washing step, therefore, leaving virtually no impurities or side products. Importantly, in some implementations, the presence of the hydrochloric acid salt in the polyphosphazes of general formulas 2, 4, and 6 may preferably be carefully monitored to avoid the undesirable formation of lithium hydrochloride (LiCl) during the lithiation step.

Regarding the purification of the lithiated polyphosphazenes of the general formula 3, 5, and 7, various techniques may be effectively used, such as solvent extraction, Soxhlet extraction, or dialysis. In some implementations, further purification may also be accomplished by the precipitation of polymers from solutions utilizing non-polar solvents. In some implementations, subsequent drying of lithiated polymers in a vacuum may be needed to ensure the complete evaporation of all organic volatiles.

While the description of one or more aspects of this invention may describe certain examples of lithiated polyphosphazenes of the general formulas 3, 5, and 7 in a semi-crystalline or crystalline forms, it will be appreciated that various aspects may be applicable to other compositions that may endow amorphous polymers. In some implementations, the compositions may contain semi-crystalline polymers. In other implementations, the compositions may contain mixtures of amorphous and semi-crystalline polymers.

While the description of one or more aspects of this invention may describe certain examples of lithiated polyphosphazenes of the general formulas 3, 5, and 7, it will be appreciated that various aspects may be applicable to SPE compositions that may comprise elastomer polymers. For example, the incorporation of fluorinated ligands, such as 2-trifluoroethoxy, may render the formation of strong intermolecular hydrogen bonds, which may endow elastic properties.

While the description of one or more aspects of this invention may describe certain examples of lithiated polyphosphazenes of the general formulas 3, 5, and 7, it will be appreciated that various aspects may be applicable to SPE compositions that may contain polymers with a high-melting point, which may render high mechanical stiffness. For example, the incorporation of aryl groups may allow π-π stacking among aryl units, which may enhance mechanical stiffness.

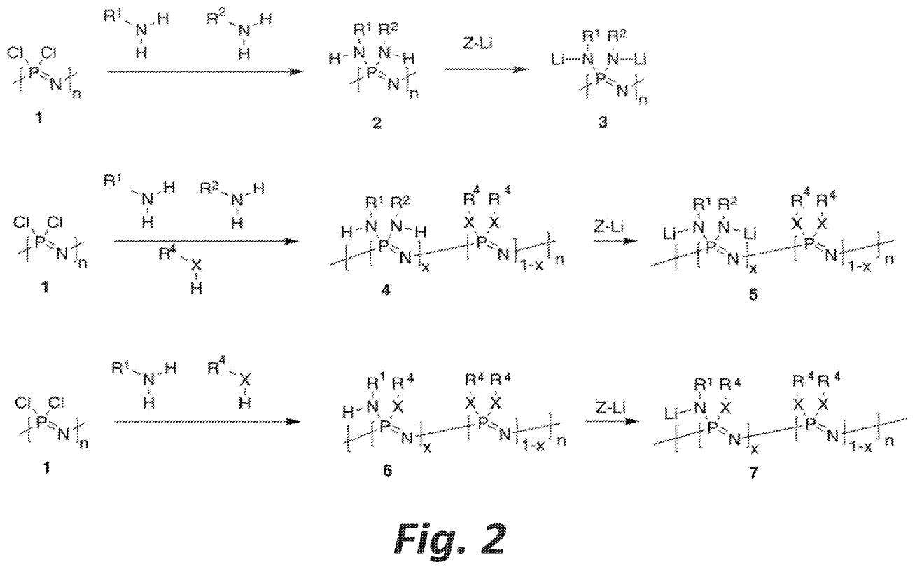

The disclosure further relates to the formation of SPE separator membranes comprised of a lithiated functionalized polyphosphazene, such as —(N=P(R¹N—Li)(R²N—Li))ₙ— (formula 3) —([N═P(R¹N—Li)(R²N—Li)]ₓ—([N═P(R⁴X)(R⁴X)]₁₋ₓ)ₙ— (formula 5), or —([N═P(R¹N—Li)(R⁴X)]ₓ—([N═P(R⁴X)(R⁴X)]₁₋ₓ)ₙ— (formula 7), where n≥2, where R¹, R² and R⁴ each independently and each occasion is selected from any of the disclosed above. For example and without limitations, R¹, R² and R⁴ can independently be, for example, but are not limited to, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, and the use of those separator membranes in Li-ion and Li-metal batteries. Illustrative examples of such separator implementations are shown in FIG. 2.

In another aspect of this disclosure, the presence of the external Lewis acid centers may be advantageously used to enable faster Li-ion transport through, for example, enhanced coordination to Li-ion and dissociation of the N—Li bond. The disclosure further relates to advantageous compositions that may include a lithiated functionalized polyphosphazene, such as —(N═P(R¹N—Li)(R²N—Li))ₙ—, —([N═P(R¹N—Li)(R²N—Li)]ₓ—([N═P(R⁴X)(R⁴X)]₁₋ₓ)ₙ—, or —([N═P(R¹N—Li)(R⁴X)]ₓ—([N═P(R⁴X)(R⁴X)]₁₋ₓ)ₙ—, where ≥2, where R¹, R², R⁴ can independently at each occasion selected from the groups disclosed above. Yet in some implementations, R¹, R², and R⁴ can independently be, for example, but are not limited to, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, and a plasticizer material, such as ethyl carbonate, propylene carbonate, PEGDME (polyethylene glycol dimethyl ether), tetraglyme, dibutyl phthalate(DBP), modified carbonate (MC3), polyethylene glycol (PEG), dimethyl phthalate (DMP), diethyl phthalate (DEP), dioctyl phthalate (DOP), cyclic phosphates (CP), succinonitrile (SN), ethyl propionate, ethyl acetate, dimethyl carbonate, ethyl methyl carbonate, diethyl carbonate, fluoroethylene carbonate, and vinylene carbonate and the use of those compositions as separator membranes in Li-ion and Li-metal batteries. Examples of such separator implementations are shown in FIG. 2.

In another aspect of this disclosure, the presence of the external Lewis acid centers may advantageously enable faster Li-ion transport through the enhanced coordination to Li-ion and dissociation of the N—Li bond. The disclosure further relates to a composition that may advantageously include blends of a lithiated functionalized polyphosphazene, such as —(N═P(R¹N—Li)(R²N—Li))ₙ—, —([N═P(RiN-Li)(R²N—Li)]ₓ—([N═P(R⁴X)(R⁴X)]₁₋ₓ)ₙ—, or —([N═P(R¹N—Li)(R⁴X)]ₓ—([N═P(R⁴X)(R⁴X)]₁₋ₓ)ₙ—, where n>2, where R¹, R² and R⁴ can independently at each occasion selected from the groups disclosed above. Yet in some implementations, R¹, R², R⁴ can independently be for example, but are not limited to, as CH₃O—CH₂—CH₂—, CH₃O—CH₂—CH₂—CH₂—, CH₃O—CH₂—OH₂—O—OH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, and another polymer, such as poly(ethyleneoxide) (PEO), polytetrafluoroethylene (PTFE), polyvinylidene fluoride (PDVF), polyvinylidene, fluoride-co-hexafluoropropylene (PVDF-HFP), polystyrene, (PS), polybutadiene (BR), polyvinylidene chloride (VDC), polymethyl methacrylate (PMMA), polyvinyl alcohol, (PVAL), polyvinyl acetate (PVA), polyphenylene oxide, (PPO), polyether ether ketone (PEEK), polyethylene terephthalate (PET), polybutylene terephthalate (PBT), polycarbonate (PC), polyether sulfone, polybenzimidazoles (PBI), polydimethylsiloxane, polyphenylene sulfide (PS), polypyrrole, polyphenylene, polyaniline, poly[bis(pentoxy)phosphazene], poly[bis(phenoxy)phosphazene], poly[(methoxyethoxyethoxy)(m-methyl phenoxy)phosphazene], and the use of those blended compositions as separator membranes in Li-ion and Li-metal batteries. Examples of such separator implementations are shown in FIG. 2.

The disclosure further relates to the separator membranes that may be advantageously prepared using a hot-press (e.g., a press with a suitable temperature in the range from around 25 to 250° C. and a suitable pressure in the range from 1 to 20 MPa). In some implementations, a lithiated polyphosphazene, such as —(N═P(R¹N—Li)(R²N—Li))ₙ—, —([N═P(R¹N—Li)(R²N—Li)]ₓ—([N═P(R⁴X)(R⁴X)]₁₋ₓ)ₙ—, or —([N═P(R¹N—Li)(R⁴X)]ₓ—([N═P(R⁴X)(R⁴X)]₁₋ₓ)ₙ—, where n a 2, where R¹, R² and R⁴ can independently at each occasion selected from the groups disclosed above. Yet in some implementations, R¹, R², and R⁴ can independently be, for example, but are not limited to, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is 20 and 51, may be initially taken and ground into a fine powder (e.g., by a mortar and pestle or other means). In some implementations, a polymer binder may be added to the finely ground powder in designed ratios and further mixed (e.g., by using ball milling or other suitable milling techniques or other suitable means). In some implementations, it may be advantageous to conduct such a procedure in an inert atmosphere to avoid undesirable reactions (e.g., hydrolysis, light degradation, oxidation). In some implementations, lithium salt or a mixture of salts, such as lithium bis(trifluoromethanesulfonyl)imide, other imide salts, LiPF₆, and/or other salts, may then be added. The blend may then be spread out into a coating and pressed (in some implementations at about 1 to 20 MPa at 25 to 250° C. temperatures for about 10 sec to about 100 hours (in some implementations, for about 1 min to about 2 hours)) to form a separator film having a thickness in the range from around 2 microns to around 200 microns (in some implementations, from around 5 microns to around 25 microns). This system may then be cooled down to room temperature to obtain a uniformly blended lithiated phosphazene-polymer-based SPE separator. Examples of such separator implementations are shown in FIG. 2.

In some implementations, blends of the lithiated polyphosphazenes such as —(N═P(R¹N—Li)(R²N—Li))ₙ—, —([N═P(R¹N—Li)(R²N—Li)]ₓ—([N═P(R⁴X)(R⁴X)]₁₋ₓ)ₙ—, or —([N═P(R¹N—Li)(R⁴X)]ₓ—([N═P(R⁴X)(R⁴X)]₁₋ₓ)ₙ—, where n≥2, where R¹, R² and R⁴ can independently at each occasion selected from the groups disclosed above. Yet in some implementations, R¹, R² and R⁴ can independently be, for example, but are not limited to, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, with other polymer(s), may be manufactured into separator membrane using various casting techniques. In one illustrative example, a lithiated poly(amidophosphazenes) and a polymer binder may be dissolved or dispersed in a common solvent in specific ratios and stirred for sufficient time (e.g., for several hours or overnight) to obtain a homogenous mixture/solution and facile degassing. In some implementations, lithium salts, such as lithium bis(trifluoromethanesulfonyl)imide or another suitable salt or salt mixture, may be added. This solution may then be cast (e.g., drop cast in a simple laboratory experiment) on a smooth, non-sticky surface (e.g., a Teflon surface) and dried in an inert atmosphere. The obtained films may be further dried in a vacuum at elevated temperatures to remove trace solvents and hence obtain robust blended lithiated polyphosphazene-polymer SPE films. Illustrative examples of such separator fabrication and implementations are shown in FIG. 2.

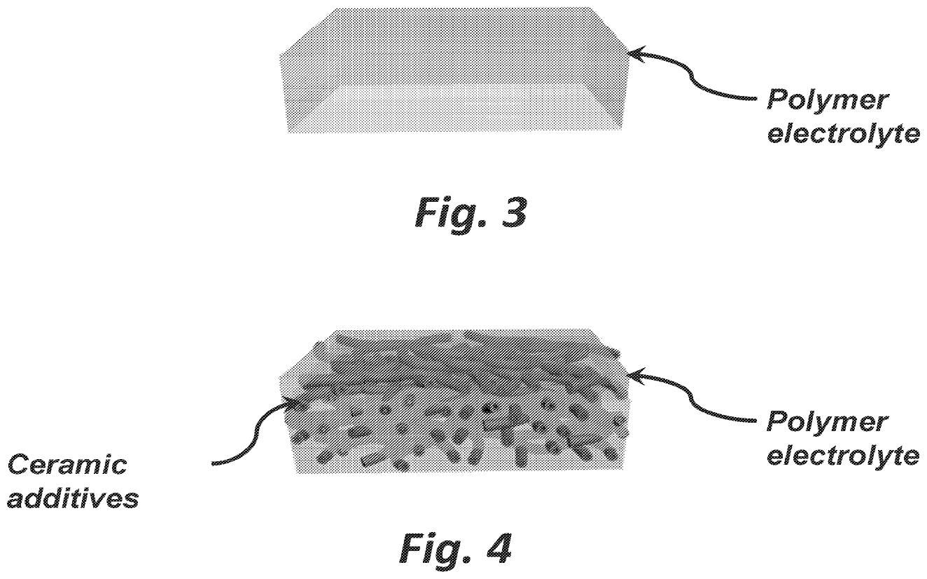

The disclosure further relates to the separator compositions that may include (i) a lithiated one or more functionalized polyphosphazene, such as —(N═P(R¹N—Li)(R²N—Li))ₙ—,—([N═P(R¹N—Li)(R²N—Li)]ₓ—([N═P(R⁴X)(R⁴X)]₁₋ₓ)ₙ—, or —([N═P(R¹N—Li)(R⁴X)]ₓ([N═P(R⁴X)(R⁴X)]₁₋ₓ)ₙ—, where n≥2, where R¹, R² and R⁴ can independently at each occasion selected from the groups disclosed above. Yet in some implementations, R¹, R², and R⁴ can independently be, for example, but are not limited to, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, and (ii) ceramic additives. In some implementations, ceramic additives may comprise inorganic (nano)particles, including elongated (nano)particles (such as (nano)fibers, (nano)wires, (nano)whiskers, etc.). In some implementations, inorganic ceramic additives may be electrically insulative and comprise aluminum oxide (e.g., Al₂O₃). Examples of such separator implementations are shown in FIG. 3.

In another aspect of this disclosure, favorable SPE compositions comprising (i) one or more of the lithiated polyphosphazenes such as —(N═P(R¹N—Li)(R²N—Li))ₙ—, —([N═P(R¹N—Li)(R²N—Li)]ₓ—([N═P(R⁴X)(R⁴X)]₁₋ₓ)ₙ—, or —([N═P(R¹N—Li)(R⁴X)]ₓ—([N═P(R⁴X)(R⁴X)]₁₋ₓ)ₙ—, where n 2, where R¹, R² and R⁴ can independently at each occasion selected from the groups disclosed above. Yet in some implementations, R¹ and R² can independently be, for example, but are not limited to, CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, (ii) ceramic (nano)fillers may be advantageously processed using a press prior to using in a Li-ion or Li metal battery. In one illustrative process flow example, (a) the lithiated polyphosphazene may be initially ground into a fine powder by suitable means of a mortar and pestle; (b) then the ceramic (nano)particle/(nano)wire/(nano)fiber fillers may be added to the finely ground lithiated polyphosphazene in desired ratios and further mixed by suitable means (e.g., ball milling or other milling technique) in a suitable environment (e.g., in an inert atmosphere). In some implementations, one or more lithium salt(s), such as lithium bis(trifluromethanesulfonyl)imide or other imide salts or LiPF₆ or other, may be added. The blend may then be pressed at a suitable pressure and temperature for a suitable time. This system may then be allowed to cool down to room temperature to obtain a uniformly blended lithiated polyphosphazenes-ceramic nanowires SPE membrane. An example of such a separator design is shown in FIG. 4.

In another aspect, favorable SPE compositions comprising (i) one or more of the lithiated polyphosphazenes such as —(N═P(R¹N—Li)(R²N—Li))ₙ—, —([N═P(R¹N—Li)(R²N—Li)]ₓ—([N═P(R⁴X)(R⁴X)]₁₋ₓ)ₙ—, or —([N═P(R⁴N—Li)(R⁴X)]ₓ—([N═P(R⁴X)(R⁴X)]₁₋ₓ)ₙ—, where n≥2, where R¹, R² and R⁴ can independently at each occasion selected from the groups disclosed above. Yet in some implementations, R¹, R², and R⁴ can independently CH₃O—CH₂—CH₂—, CH₃O—CH₂—CH₂—CH₂—, CH₃O—CH₂—CH₂—O—CH₂—CH₂—, CH₃O—CH₂—CH₂—(O—CH₂—CH₂)ₙ— where n=2-10, fluorinated alkyl, such as CF₃—CH₂—, FSO₂—, CF₃—SO₂—, and where x is ≥0 and ≤1, and (ii) ceramic (nano)fillers may be prepared using a solution casting technique. For this, ceramic nanoparticles (e.g., nanowires (NWs)) may be dispersed in a suitable solvent (e.g., a tetrahydrofurane, THF) by means of ultrasonication for a suitable time (e.g., for 0.3-3000 min, in some implementations from around 10-100 min). The obtained NWs dispersion may then be mixed with the solution of lithiated poly(amidophosphazenes) in the same solvent (e.g., THF), followed by additional sonication for a suitable time (e.g., for 0.3-3000 min, in some implementations from around 10-100 min). The resulting solution may then be drop-casted as a thin layer of the suitable thickness on the PTFE sheet and dried in the vacuum overnight to form a free-standing membrane with an average thickness in the range from around 5 to around 50 microns. Illustrative example of such separator implementations is shown in FIG. 4.

Commercial cathode and anode materials, such as lithium nickel cobalt manganese oxide (NMC), lithium cobalt oxide (LCO), lithium cobalt aluminum oxide (NCA), lithium nickel cobalt manganese aluminum oxide (NMCA), lithium manganese oxide (LMO), lithium iron phosphate (LFP) and other cathode compositions as well as graphite, lithium metal or other suitable anode compositions, may be employed for evaluating the electrochemical performance of aforementioned lithiated polyphosphazene-based SPEs as well as their used in fully functional Li-ion or Li-metal batteries. In some implementations, a cathode (or anode) may be made by directly adding the suitable lithiated polyphosphazenes in the electrode slurry prior to mixing, casting, drying and densifying. In one illustrative example, suitable lithiated polyphosphazene-based SPE and a suitable polymer binder may first be mixed in suitable volume percentages (e.g., from around 99:1 to around 2:1) and added to a suitable solvent. In some implementations, one or more of suitable lithium salt, such as lithium bis(trifluromethanesulfonyl)imide, may also be added to the polymer solution (or suspension). This mixture may then be stirred until all the solids are uniformly dissolved (or dispersed). Subsequently, the electrode material and conductive additive carbon material(s) may be added to this solution to form a viscous slurry. This slurry may then be stirred for sufficient time and suitable conditions to attain a homogeneous mixture. This slurry may then be cast on a suitable current collector foil. The cast slurry may then be dried (e.g., for several hours at elevated temperatures in an inert atmosphere) to form an electrode. Thus produced electrode may be subjected to a cold or hot calendaring in a suitable environment (in some implementations, in an inert atmosphere) to densify and smoothen the electrode and to obtain better electronic contact between individual active material (e.g., cathode) particles.

In some implementations, electrodes may be made with commercial active materials and the aforementioned lithiated polyphosphazenes-based SPE compositions by means of (i) suitable milling (e.g., ball milling), (ii) casting (e.g., spray-casting) and (iii) hot-pressing. In one illustrative example, suitable lithiated polyphosphazene may first be ground into a fine powder. To this powder, the required ratios of electrode active material, a suitable polymer binder (e.g., polyvinylidene fluoride), and a conductive additive (e.g., carbon black) may then be added and further mixed. To achieve high levels of homogenization, this mixture may then be ball-milled in an inert atmosphere for a suitable time (e.g., 10 minutes) with an inert milling media. This slurry may then be cast onto a suitable current collector and pressed at elevated temperatures.

In some implementations, it may be advantageous to use lithiated phosphazenes of formulas 3, 5, and 7 as additives to electrolyte formulations for thermal protection to reduce risks associated with thermal runaway, overcharge, and HT storage. In some implementations, lithiated phosphazenes of formulas 3, 5, and 7 can be added in quantities from 0.1 to 2 wt. % in the electrolyte formulation. A typical electrolyte formulation may comprise a cyclic carbonate, such as ethyl carbonate fluoroethylene carbonate, and vinylene carbonate, a linear carbonate, such as dimethyl carbonate, ethyl methyl carbonate, and diethyl carbonate, a lithium salt, such as lithium hexafluorophosphate, lithium bis(fluorosulfonyl) imide, and lithium difluorophosphate, an ester, such as ethyl propionate and ethyl acetate, and other additives, such as nitriles and sulfur-based compounds.

FIGS. 4, 5, 6, 7 and 8 show illustrative examples of suitable building blocks for use in Li-ion or Li metal batteries comprising lithiated polyphosphazenes-based SPE compositions. In some implementations, the following polymer binders may be utilized within the SPE-comprising electrodes in Li-ion and Li-metal batteries: polyvinylidene fluoride (PVDF), polyvinylidene, fluoride-co-hexafluoropropylene (PVDF-HFP), polyvinyl acetate (PVA), carboxymethyl cellulose (CMC), and polyetherimide (PEI).

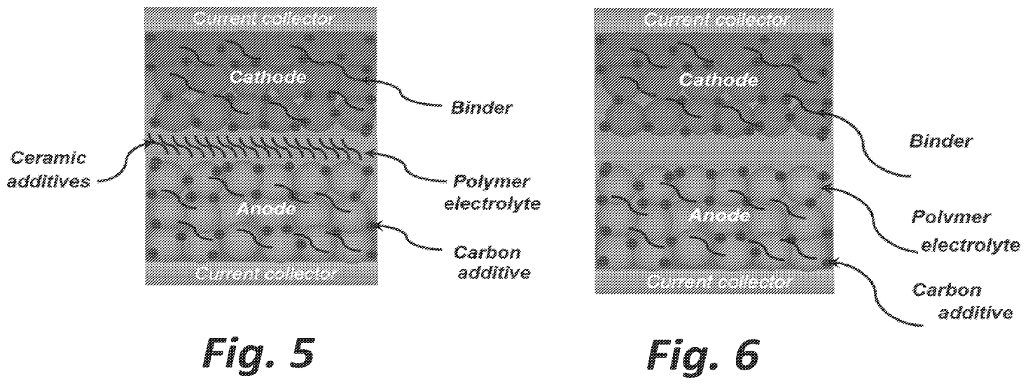

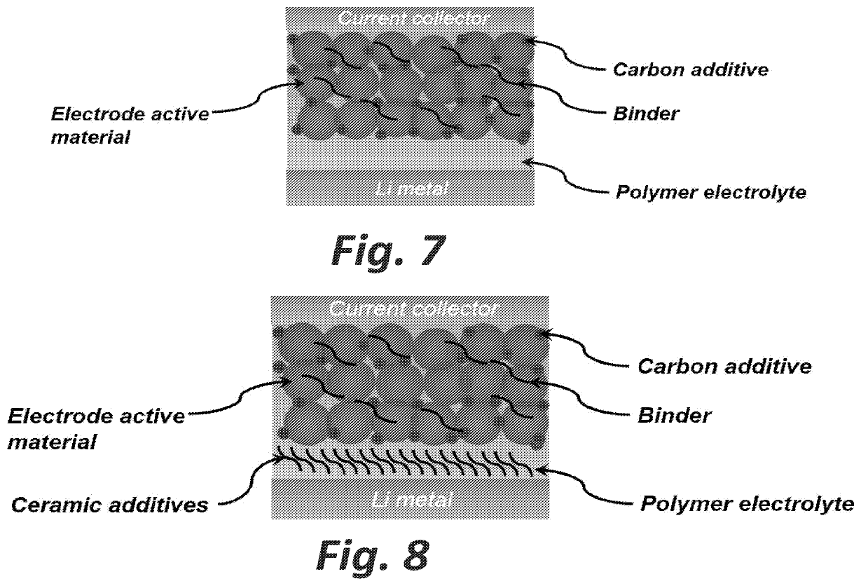

All-solid-state batteries may be assembled using electrodes and separators described in this disclosure. Examples of such battery implementations are shown in FIG. 4. In another aspect, the battery implementations can be with separators reinforced by ceramic nanowires fillers. Examples of such battery implementations are shown in FIG. 5. In another aspect, all-solid-state batteries can be assembled using electrodes and separators described in this invention and Li-metal foil. Examples of such battery implementations are shown in FIG. 6. Yet in another aspect, all-solid-state batteries can be assembled using electrodes and separators reinforced by ceramic nanowires fillers, which are described in this invention, and Li-metal foil. Examples of such battery implementations are shown in FIG. 7.

Also disclosed herein are methods of making a battery, wherein the method comprises: providing an anode material; providing a cathode material; and providing an electrolyte comprising from greater than 0 wt % to 100% of any of the disclosed herein polymers polymer compositions. It is understood that the anodes, cathodes, and electrolytes can be any of the disclosed above anodes, cathodes, or electrolytes.

In still further aspects, disclosed herein are methods of making the separators wherein the method comprises forming a film comprising any of the disclosed above polymers and/or polymer compositions. Some examples of the methods of making such separators are disclosed herein.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

The examples shown herein are directed to the synthesis of lithiated polyphosphazenes and the use of these compounds in Li-ion battery technology as solid polymer electrolytes (SPEs). However, it is understood that similar methods can be used to obtain Na— or K— modified polyphosphazenes.

Polymer electrolytes in which anion centers covalently bound within the polymer and only Li-ions can freely move between them are also called single Li-ion conducting PEs. In single L-ion conducting PEs only L-ions are mobile (Li⁺ transference numbers >0.95), thus avoiding any transfer of anion groups, which largely eliminates parasitic side reactions caused primarily by mobile anionic species, lowers internal impedance, and increases cycle lifetimes of batteries. However, in the-state-of-the-art examples of single Li-ion conducting PE conductivities did not exceed 10V S cm⁻¹ at 25° C. in the best case. The exemplary SPEs disclosed herein exhibit single Li-ion conduction properties with Li-ion transference numbers close to 1.

The examples described herein are also directed to the manufacturing of solid polymer electrolyte composites made of lithiated polyphosphazenes (or other metal-based polyphosphazenes) and additives, such as ceramic nanowires, polymer electrolytes, Li salts (or other metal salts), and plasticizers, and the use of such composites in Li-ion battery devices (or Na, or K cells, for example).

### Example 1

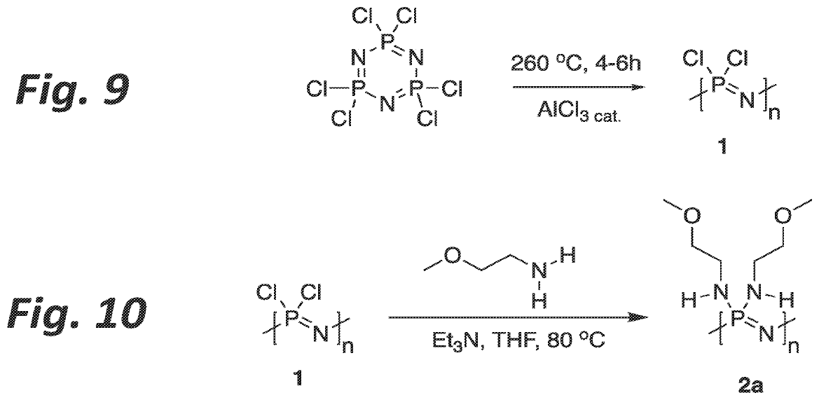

FIG. 9 illustrates an example synthesis procedure for the formation of polydichlorophosphazene. Hexachlorophosphazene (10.0 g, 28.8 mmol) and AlCl₃ (0.30 g, 2.2 mmol) were added to a glass ampule and purged with N₂ before flame sealing at reduced pressure (<50 mTorr). The sealed ampule was then placed in a convection oven at 260° C. for 4-8 h yielding a viscous clear gel. ³¹P NMR (δ, CDCl₃): −18 ppm (s).

### Example 2

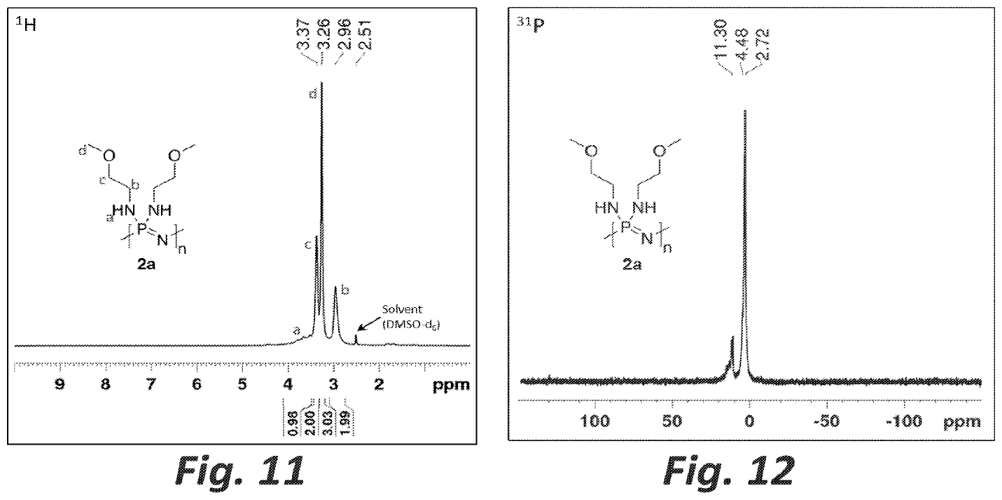

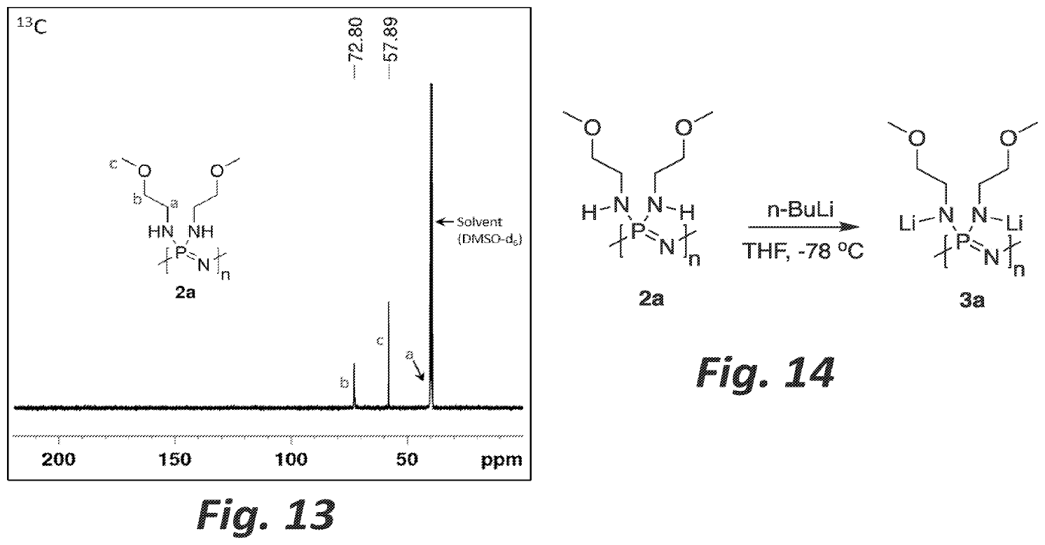

FIG. 10 illustrates an example synthesis procedure utilized for the formation of 2a: (i) polydichlorophosphazene 1 (4.18 g, 28.6 mmol) was dissolved in 250 mL of THF under N₂; (ii) triethylamine (TEA; 12.8 mL, 91.7 mmol) and 2-methoxyethylamine (7.5 mL, 86 mmol) were added slowly via syringe to the solution of 1; (iii) the reaction mixture was then refluxed at 80° C. for four days to allow for complete substitution; (iv) the resulting solution was then filtered to remove triethylamine hydrochloride and (v) concentrated by reduced pressure rotary evaporation; (vi) the crude polymer was then dialyzed against methanol for two days followed by (vii) dialysis against water for two days; (iix) the polymer was then concentrated again and dried for two days under vacuum to give 5.12 g of 2a (80.1% yield). FIGS. 11-13 show examples of the NMR characterizations of the material produced according to the procedure described in FIG. 10. ¹H NMR (δ, d₆-DMSO): 2.96 (broad, s, 2H), 3.37 (broad, s, 2H), 3.25 (broad, s, 3H), 3.67 (shoulder, NH); ³¹P NMR (δ, d₆-DMSO):2.72 to 11.30 (broad, multiple peaks, phosphazene phosphorous); ¹³C NMR (δ, d₆-DMSO): 57.89, 72.80 (solvent peak covers a third carbon peak).

### Example 3

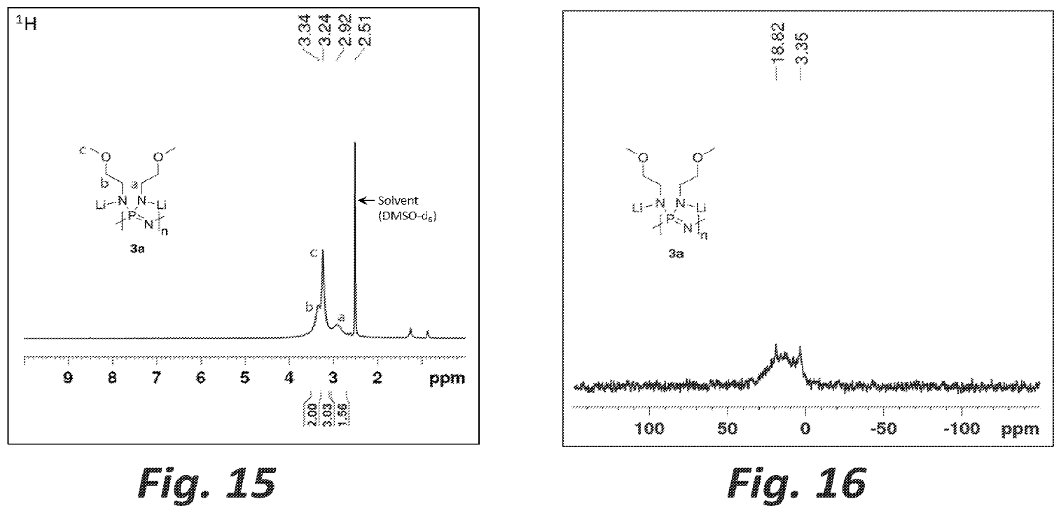

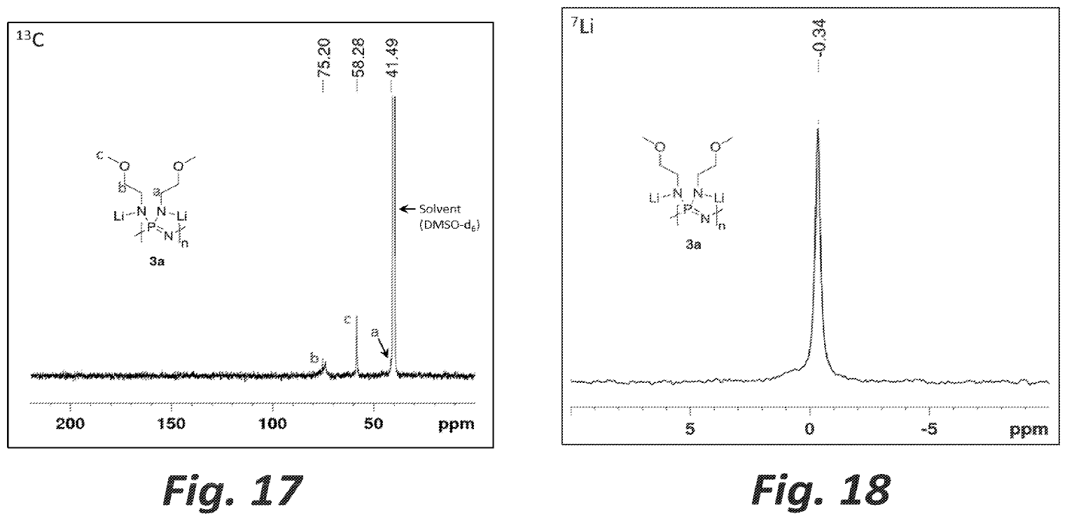

FIG. 14 illustrates an example synthesis procedure utilized for the formation of 3a: (i) 2a (3.0 g, 13 mmol) was dissolved in 100 mL of THF and cooled to −78° C. in a dry ice/acetone bath; (ii) n-Butyllithium (in hexane, 26 mmol) was then slowly added via syringe to the polymer solution under inert conditions and stirred for four hours at −78° C. to lithiate the polymer; (iii) the reaction mixture was then warmed to room temperature, and the THF evaporated at reduced pressure; (iv) the lithiated polymer was then transferred to an Ar glovebox (H₂O <0.1 ppm) and washed several times with anhydrous THF to remove any impurities and dried thoroughly under vacuum to give 1.9 g of 3a (60% yield). FIGS. 15-18 show examples of the NMR characterizations of the material produced according to this procedure: ¹H NMR (δ, d₆-DMSO): 2.92 (broad, s, 2H), 3.34 (broad, s, 2H), 3.24 (broad, s, 3H); 31P NMR (δ, d₆DMSO): −3.7 to 32.2 (broad multiple peaks, phosphazene phosphorous): ¹³C NMR (δ, d₆DMSO): 41.49, 58.28, 75.20; Li NMR (δ, d₆DMSO): −0.34 (s, Li⁺N⁻).

### Example 4

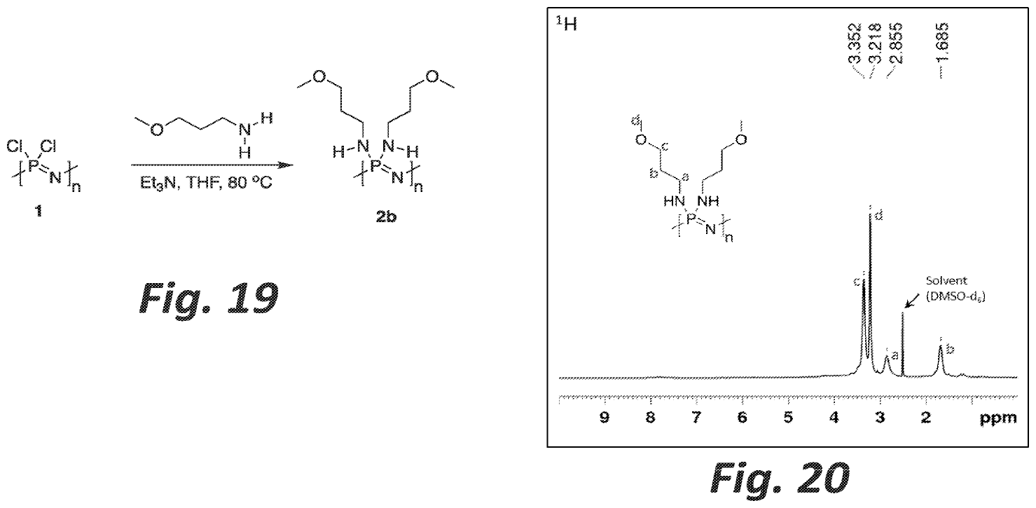

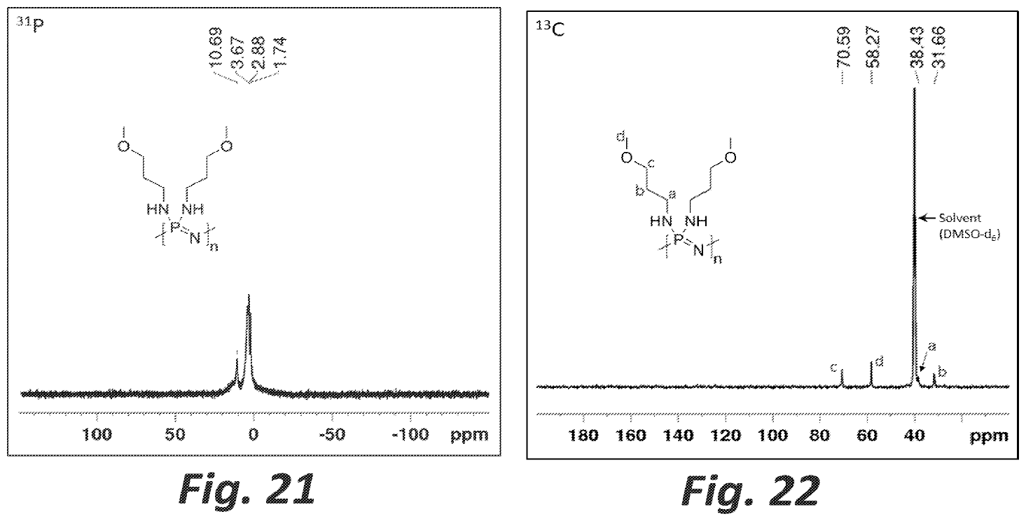

FIG. 19 illustrates an example synthesis procedure utilized for the formation of 2b: (i) freshly-prepared 1 (7.09 g, 48.58 mmol) was dissolved in 250 mL of THF under Ar; (ii) triethylamine (TEA; 21.7 mL, 156 mmol) and 2-methoxypropylamine (14.9 mL, 146 mmol) were combined separately and added slowly via syringe to the solution of 1; (iii) the reaction mixture was then refluxed at 80° C. for two days to allow for complete substitution; (iv) the resulting solution was then centrifuged to remove TEA-HCl and (v) concentrated by reduced pressure rotary evaporation; (vi) the crude polymer was then re-dissolved in CHCl₃ and precipitated with diethyl ether several times to remove impurities; (vii) the precipitated white solid was then dried overnight under vacuum to give 6.19 g of 2b (50.7% yield). FIGS. 20-22) show examples of the NMR characterizations of the material produced according to this procedure: ¹H NMR (δ, d₆-DMSO): 1.69 (broad, s, 2H), 2.86 (broad, s, 2H), 3.22 (broad, s, 3H), 3.35 (broad, s, 2H); ³¹P NMR (δ, d₆-DMSO): 1.74 to 10.69 (broad multiple peaks, phosphazene phosphorous); ¹³C NMR (δ, d₆-DMSO): 31.66, 3843, 58.27, 70.59.

### Example 5

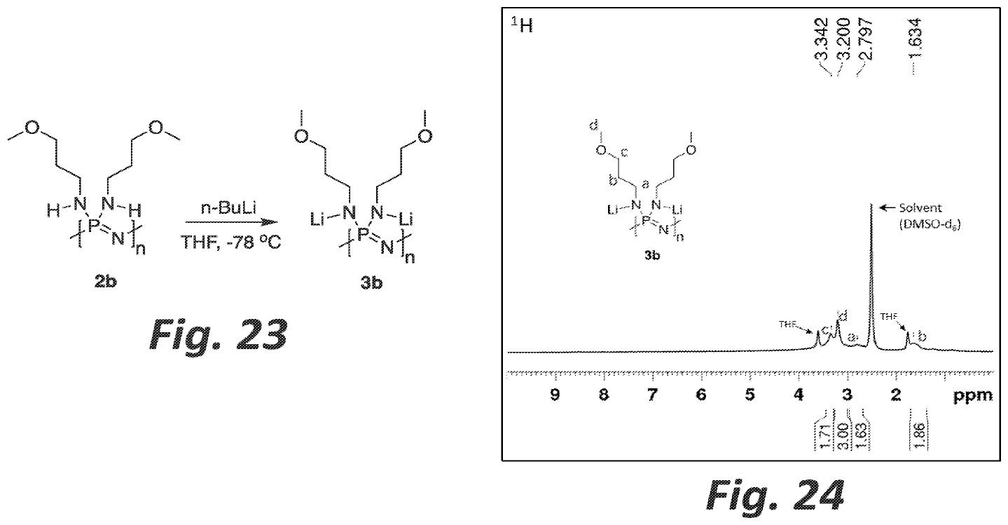

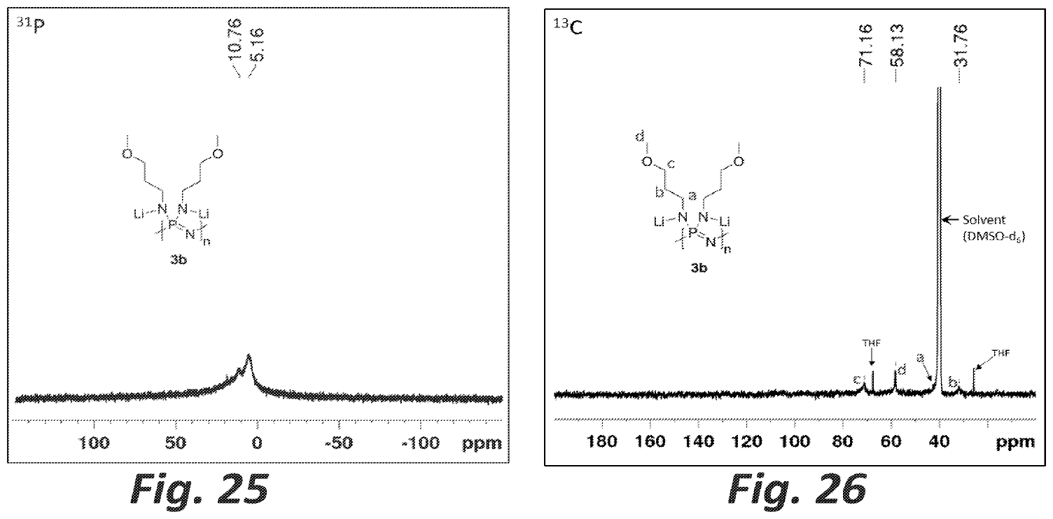

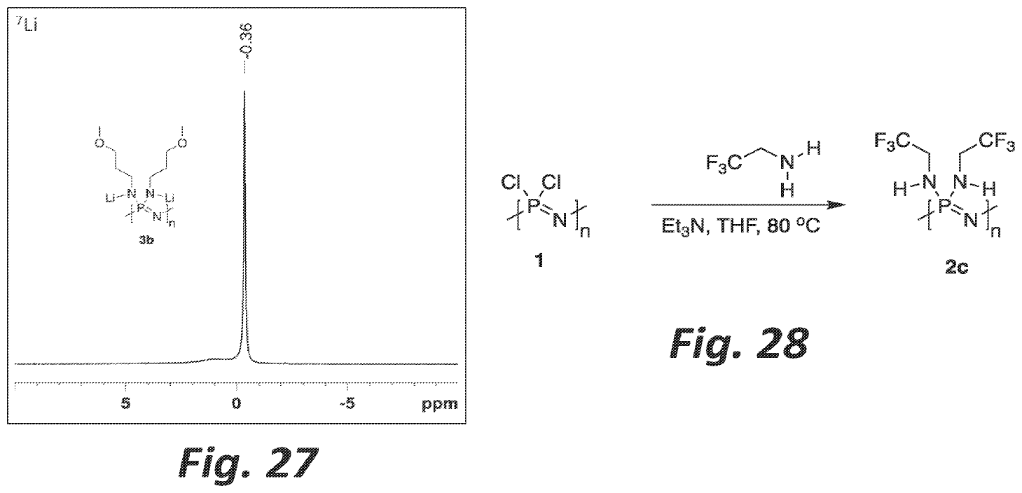

FIG. 23 illustrates an example synthesis procedure utilized for the formation of 3b: (i) 2b (5.62 g, 22.4 mmol) was dissolved in 150 mL of THF and cooled to −78° C. in a dry ice/acetone bath; (ii) n-butyllithium (in hexane, 26 mmol) was then slowly added via syringe to the polymer solution under inert conditions and stirred for four hours at −78° C. to lithiate the polymer; (iii) the reaction mixture was then warmed to room temperature and transferred to an Ar glovebox (H₂O <0.1 ppm) and (iv) filtered before washing several times with anhydrous THF to remove any impurities and (v) dried thoroughly under vacuum to give 5.89 g of 3b (85.4% yield). FIGS. 24-26 show examples of the NMR characterizations of the material produced according to this procedure: ¹H NMR (δ, d₆-DMSO): 1.63 (broad, s, 2H), 2.80 (broad, s, 2H), 3.34 (broad, s, 2H), 3.20 (broad, s, 3H); ³¹P NMR (δ, d₆-DMSO): 5.16 to 10.76 (broad, two peaks, phosphazene phosphorous); ¹³C NMR (δ, d₆-DMSO): 31.76, 42.19, 58,13, 71.16; 7Li NMR (δ, d₆-DMSO): −0.36 (s, Li⁺N⁻).

### Example 6

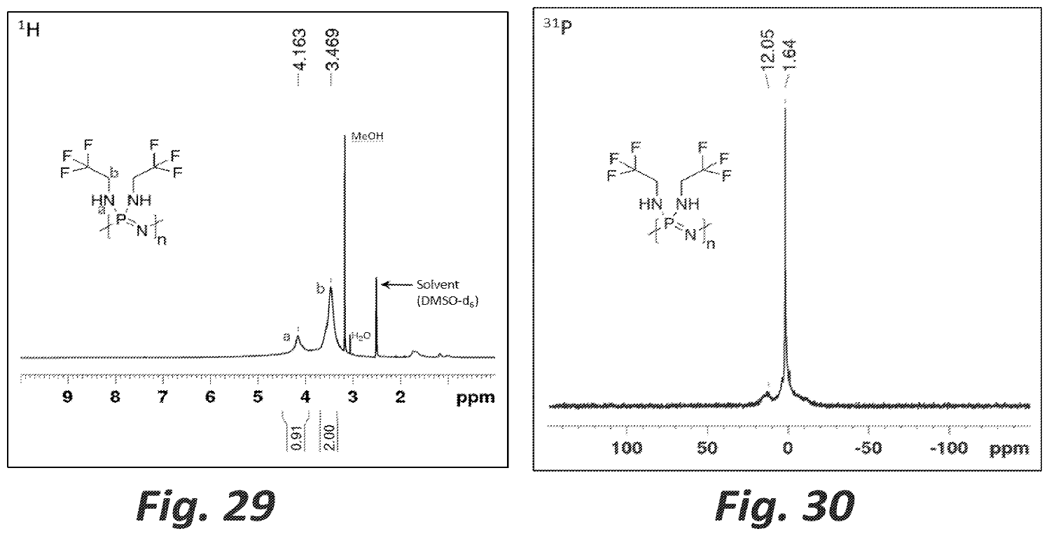

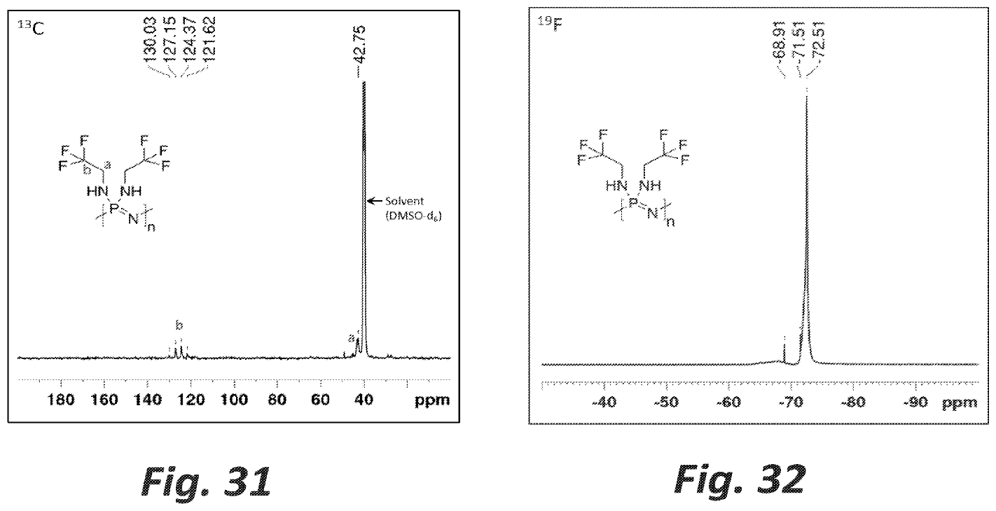

FIG. 28 illustrates an example synthesis procedure utilized for the formation of 2c: (i) the freebase trifluoroethylamine was prepared by refluxing trifluoroethylamine hydrochloride (22.3 g, 164 mmol) with triethylamine (45.8 mL, 329 mmol) in 150 mL of THF for 6 h; (ii) the solution was then filtered to remove TEA·HCl and the trifluoroethylamine was isolated; (iii) freshly-prepared 1 (8.00 g, 54.8 mmol) was dissolved separately in 100 mL of THF under Ar; (iv) the trifluoroethylamine solution was then added slowly to the 1/THF solution, along with excess triethylamine (26.7 mL, 0.192 mmol) and refluxed at 80° C. for two days under Ar; (v) the resulting solution was then filtered to remove TEA·HCl and concentrated by reduced pressure rotary evaporation; (vi) the crude polymer was then re-dissolved in methanol and dialyzed against methanol for two days followed by dialysis against chloroform for two days; (vii) the polymer was then concentrated again and dried overnight under vacuum to give 8.14 g of 2c (54.8% yield). FIGS. 29-32 show examples of the NMR characterizations of the material produced according to this procedure: ¹H NMR (δ, d₆-DMSO): 3.47 (broad, s, 2H), 4.16 (broad, s, NH); ³¹P NMR (δ, d₆-DMSO): 1.64 (sharp, phosphazene phosphorous), 12.05 (broad, phosphazene phosphorous); ¹³C NMR (δ, d₆-DMSO): 42.75 (s), 121.62 to 130.03 (q, CF₃); ¹⁹F NMR (δ, d₆-DMSO): 72.51.

### Example 7

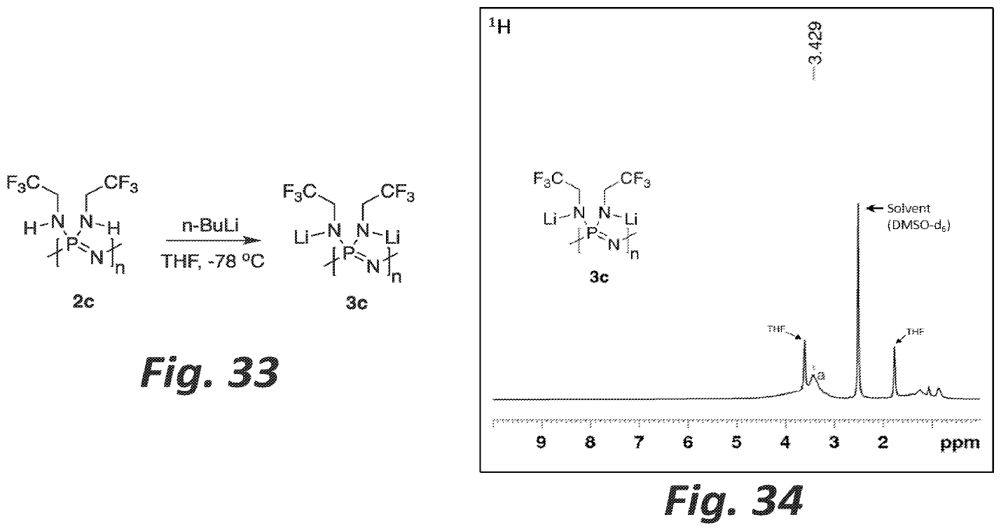

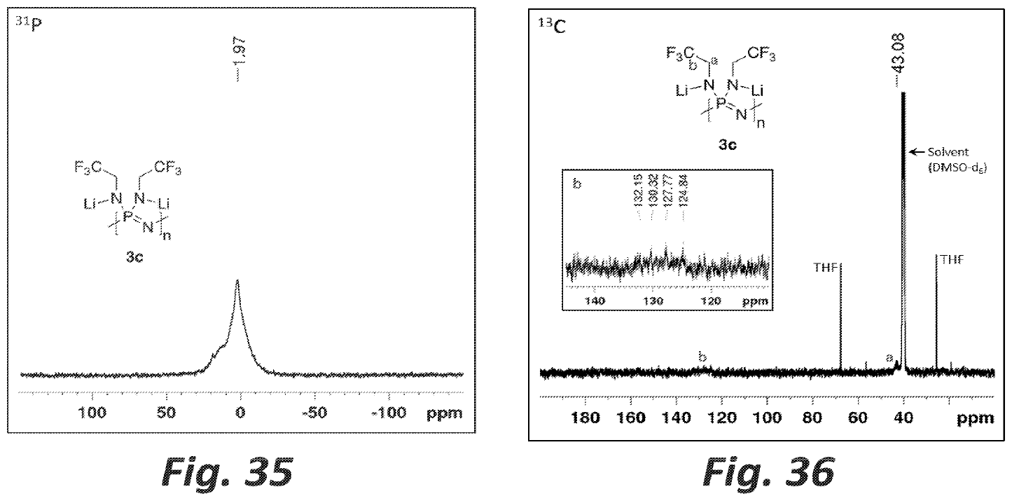

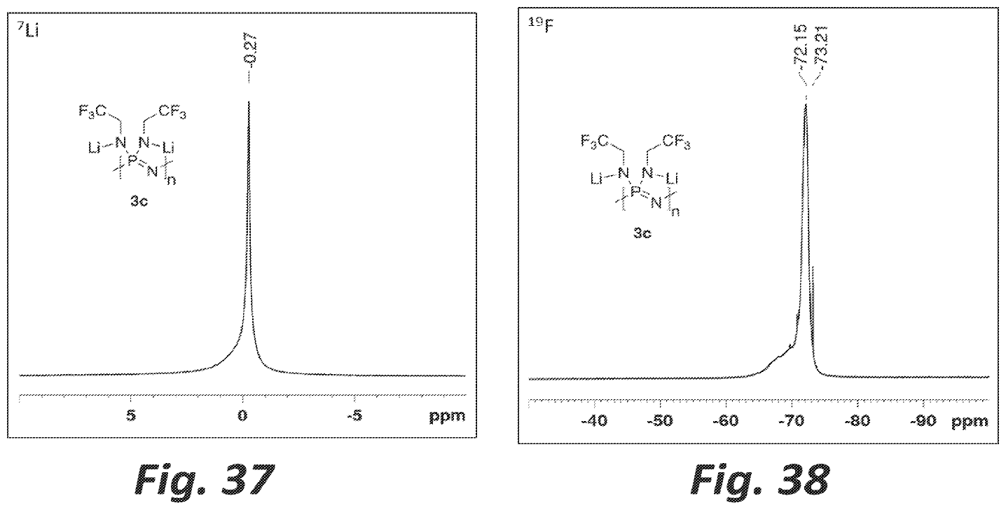

FIG. 33 illustrates an example synthesis procedure utilized for the formation of 3c: (i) 2c (7.86 g, 29.0 mmol) was dissolved in 150 mL of THF and cooled to −78° C. in a dry ice/acetone bath; (ii) n-butyllithium (in hexane, 58.0 mmol) was then slowly added via syringe to the polymer solution under inert conditions and stirred for four hours at −78° C. to lithiate the polymer; (iii) the reaction mixture was then warmed to room temperature and transferred to an Ar glovebox (H₂O <0.1 ppm) and (iv) filtered before washing several times with anhydrous THF to remove any impurities and (v) dried thoroughly under vacuum to give 8.20 g of 3c (53.4% yield). FIGS. 34-38 show examples of the NMR characterizations of the material produced according to this procedure: ¹H NMR (δ, d₆-DMSO): 3.43 (broad, s, 2H); ³¹P NMR (δ, d₆-DMSO): 1.97 (broad, phosphazene phosphorous); ¹³C NMR (δ, d₆-DMSO): 43.08 (s), 124.84 to 132.15 (q, CF₃); ¹⁹F NMR (δ, d₆-DMSO): −72.15; ⁷Li NMR (δ, d₆-DMSO): −0.27 (s, Li⁺N⁻).

### Example 8

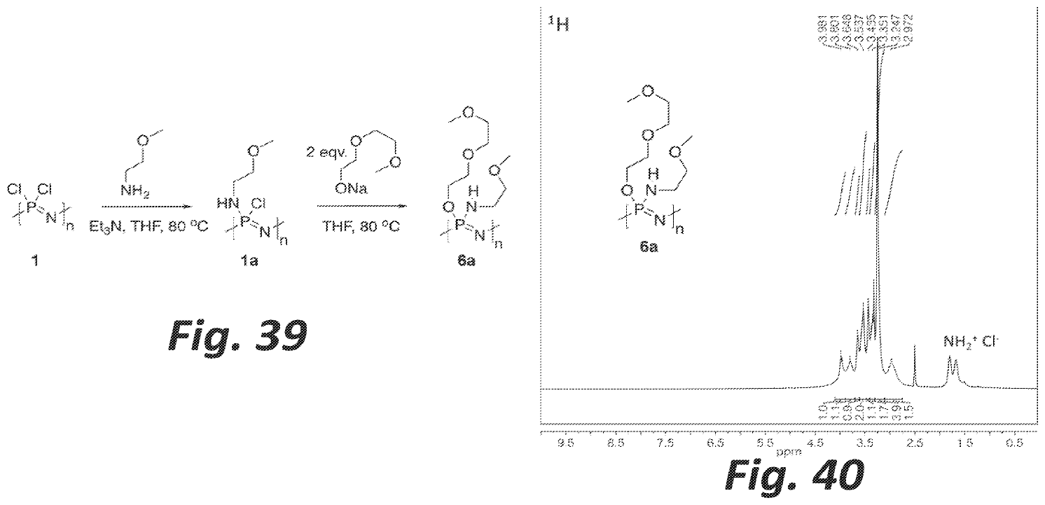

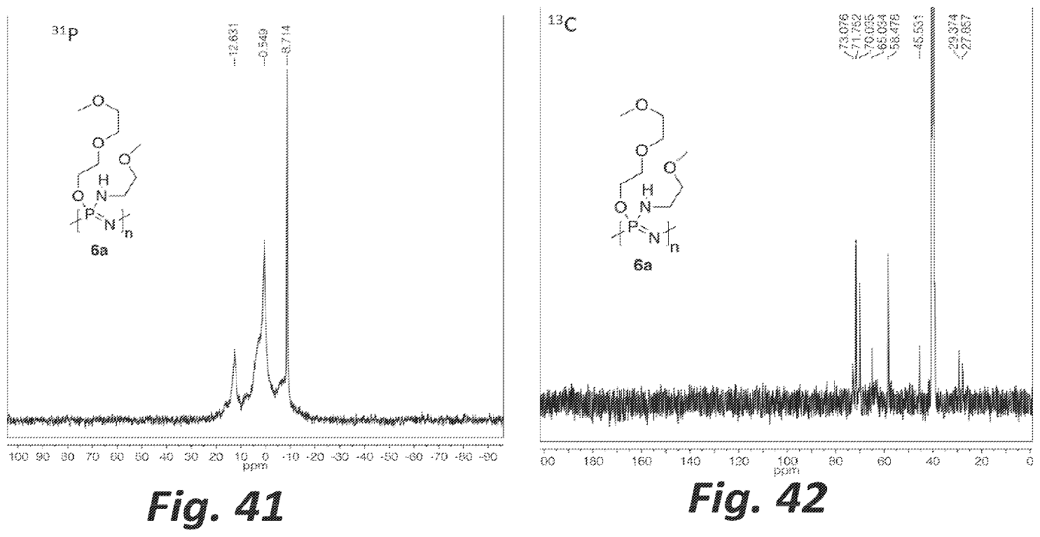

FIG. 39 illustrates an example synthesis procedure(s) utilized for the formation of 1a and 6a: (i) freshly-prepared 1 (4.49 g, 38.7 mmol) was dissolved in 200 mL of THF under Ar; (ii) triethylamine (5.9 mL, 43 mmol) and 2-methoxyethylamine (3.37 mL, 38.7 mmol) were combined separately and added slowly via syringe to the PDCP solution; (iii) the reaction mixture was then refluxed at 80° C. for 24 h to form 1a; (iv) sodium hydride (1.67 g, 0.0697) was prepared by dissolving the protective mineral oil in heptane and decanting three times before drying; (v) THF (30 mL) was added to the NaH along with 2-(2-methoxyethoxy)ethanol (9.13 mL, 77.5 mmol) under inert conditions and stirred at room temperature for four hours to form the sodium alkoxide salt; (vi) the sodium alkoxide solution was then added to 1a carefully not to add any unreacted NaH; (vii) the reaction mixture was allowed to reflux for 72 h to form the di-substituted polymer and was then (viii) centrifuged to remove NaCl and TEA-HCl side products and (ix) concentrated by rotary evaporation; (x) the brown gel was then dialyzed against methanol for six days and dried thoroughly under vacuum. FIGS. 40-42 show examples of the NMR characterizations of the material(s) produced according to this procedure: ¹H NMR (δ, d₆-DMSO): 2.97 (broad, s, 2H), 3.25 (s, 3H), 3.35 (broad, s, 3H), 3.44 (m, broad, 2H), 3.54 (m, broad, 4H), 3.65 (broad, s, NH), 3.80 (broad, s, 2H), 3.98 (m, broad, 2H); ³¹P NMR (δ, d₆-DMSO): −8.66 (s, P₁), 1.44 (m, broad, P₂), 13.3 (s, P₃); ¹³C NMR (δ, d₆-DMSO): 27.85 (m, 1C), 29.40 (s, 1C), 45.55 (m, 1C), 58.41 (d, 1C), 65.08 (s, 1C), 70.16 (s, 1C), 71.87 (s, 1C), 72.93 (m, 1C).

### Example 9

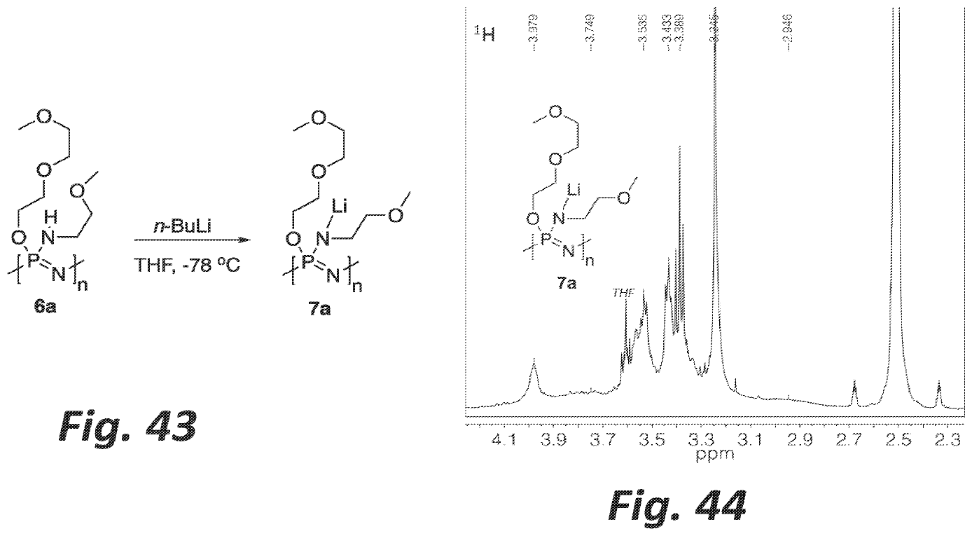

FIG. 43 illustrates an example synthesis procedure(s) utilized for the formation of 7a: (i) 6a (2.10 g, 8.81 mmol) was dissolved in 150 mL of THF and cooled to −78° C. in a dry ice/acetone bath: (ii) n-butyllithium (in hexane, 9.7 mmol) was then slowly added via syringe to the polymer solution under inert conditions and stirred for four hours at −78° C. to lithiate the polymer; (iii) the reaction mixture was then warmed to room temperature, and the solvent evaporated. (iv) The crude product was then transferred to an Ar glovebox (H₂O <0.1 ppm) and re-dissolved in THF, and precipitated with hexane to remove soluble impurities.

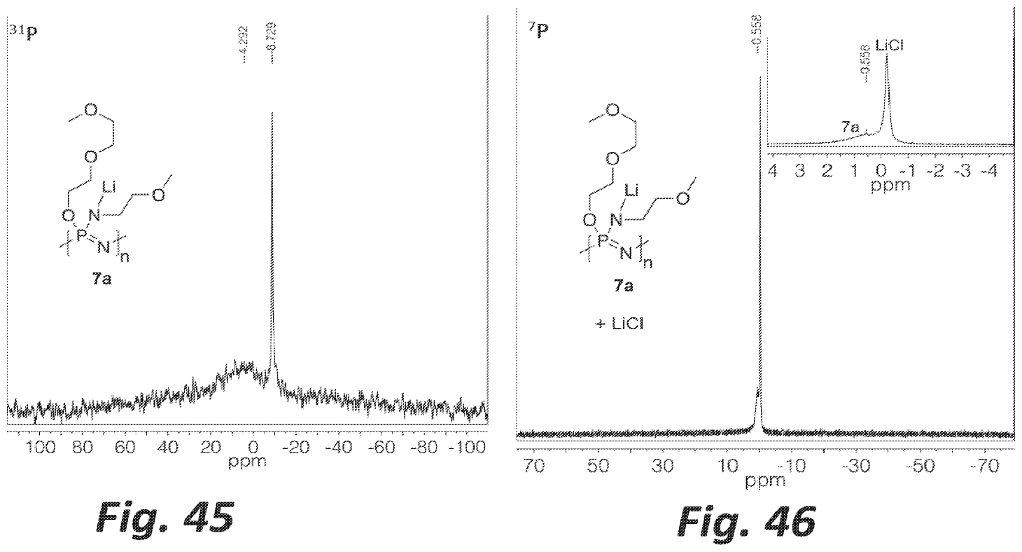

The solid was separated via filtration before washing several times with anhydrous hexane and dried thoroughly under vacuum to give 1.92 g of 7a (89.2% yield). FIGS. 44-46 show examples of the NMR characterizations of the material(s) produced according to this procedure: ¹H NMR (δ, d₆-DMSO): 2.94 (broad, s, 2H), 3.25 (s, 3H), 3.39 (t, 3H), 3.43 (m, broad, 2H), 3.53 (m, broad, 4H), 3.74 (s, broad, 2H), 3.98 (m, broad, 2H); ³¹P NMR (δ, d₆-DMSO): −8.71 (s, P₁), 0.81 (m, broad, P₂), 8.02 (m, P₃); ⁷Li NMR (δ, d₆-DMSO): 0.558 (s, broad, Li⁺N⁻).

### Example 10

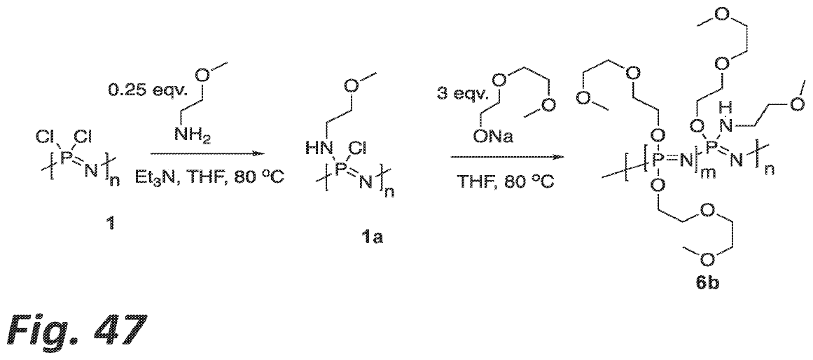

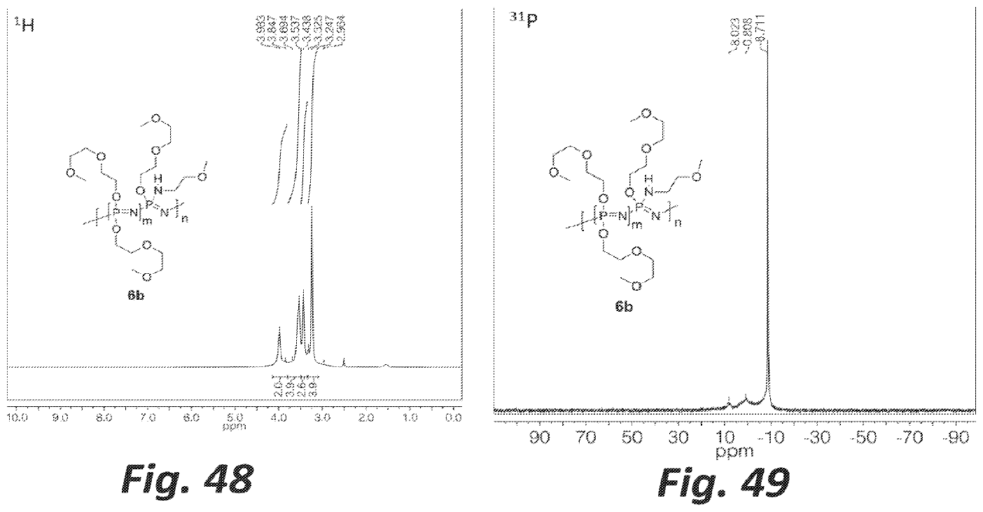

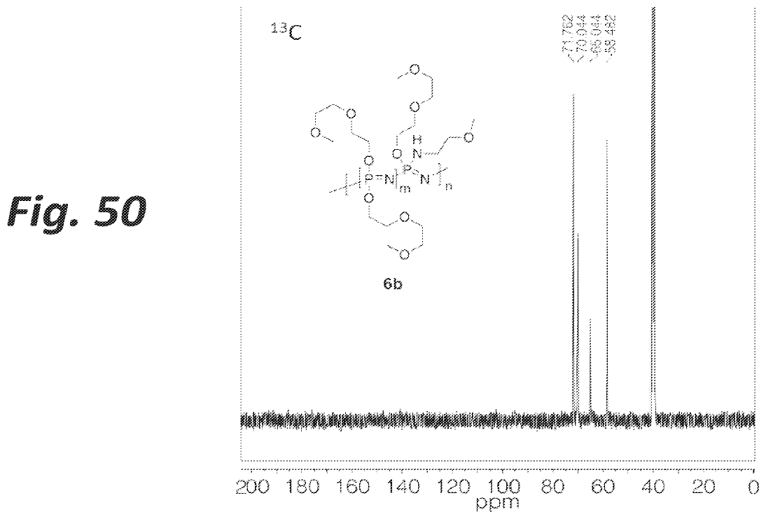

FIG. 47 illustrates an example synthesis procedure(s) utilized for the formation of 1b and 6b: (i) freshly-prepared 1 (5.39 g, 46.5 mnol) was dissolved in 150 mL of THF under Ar; (ii) triethylamine (1.94 mL, 14.0 mmol) and 2-methoxyethylamine (1.01 mL, 11.6 mmol) were combined separately and added slowly via syringe to the PDCP solution: (iii) the reaction mixture was then refluxed at 80° C. for 24 h to form 1b; (iv) sodium hydride (3.13 g, 130.2 mmol) was prepared by dissolving the protective mineral oil in heptane and decanting three times before drying; (v) THF (75 mL) was added to the NaH along with excess 2-(2-methoxyethoxy)ethanol (16.4 mL, 140 mmol) under inert conditions and stirred at room temperature for four hours to form the sodium alkoxide salt; (vi) the sodium alkoxide solution was then added to 1b carefully not to add any unreacted NaH; (vii) the reaction mixture was allowed to reflux for 72 h to form the di-substituted polymer, (viii) then centrifuged to remove NaCl and TEA-HCl side products and (ix) concentrated by a rotary evaporation; (x) the brown gel was then dialyzed against methanol for six days and dried thoroughly under vacuum to give 1.24 g of 6b (11.2% yield). FIGS. 48-50 show examples of the NMR characterizations of the material(s) produced according to this procedure: ¹H NMR (δ, d₆-DMSO): 2.96 (broad, s, 2H), 3.26 (s, 3H), 3.32 (broad, s, 3H), 3.44 (m, broad, 2H), 3.55 (m, broad, 4H), 3.69 (broad, s, 2H), 3.85 (broad, s, NH), 3.98 (m, broad, 2H); ³¹P NMR (δ, d₆-DMSO): −8.71 (s, P₁), 0.81 (m, broad, P₂), 8.02 (m, P₃); ¹³C NMR (δ, d₆-DMSO): 58.48 (s, 1C), 65.04 (s, 1C), 70.04 (s, 1C), 71.76 (s, 1C).

### Example 11

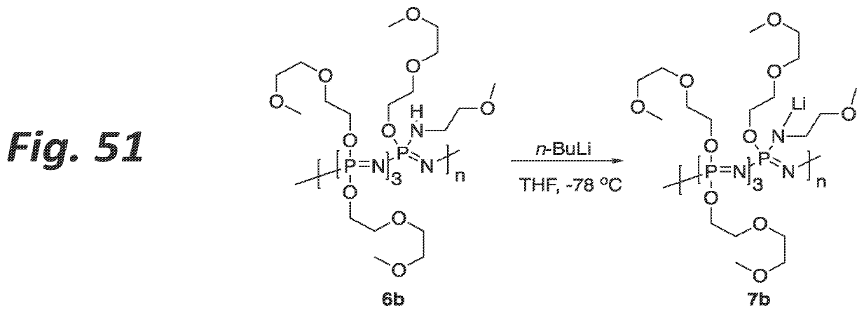

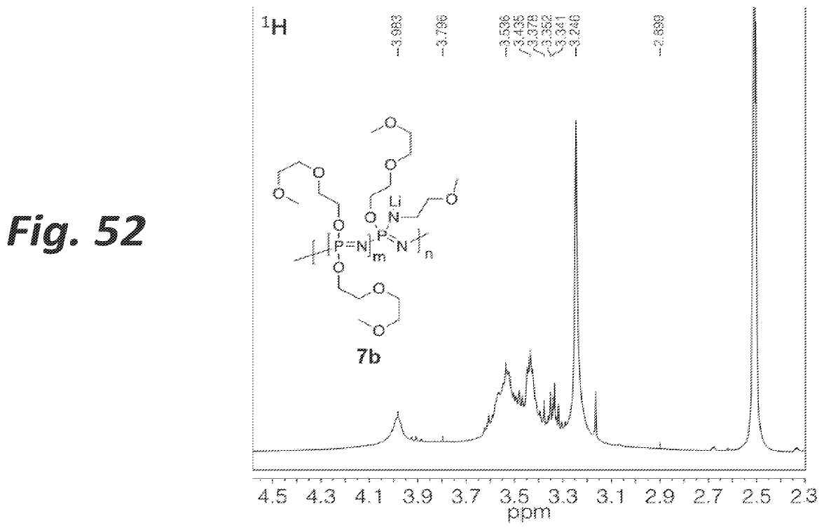

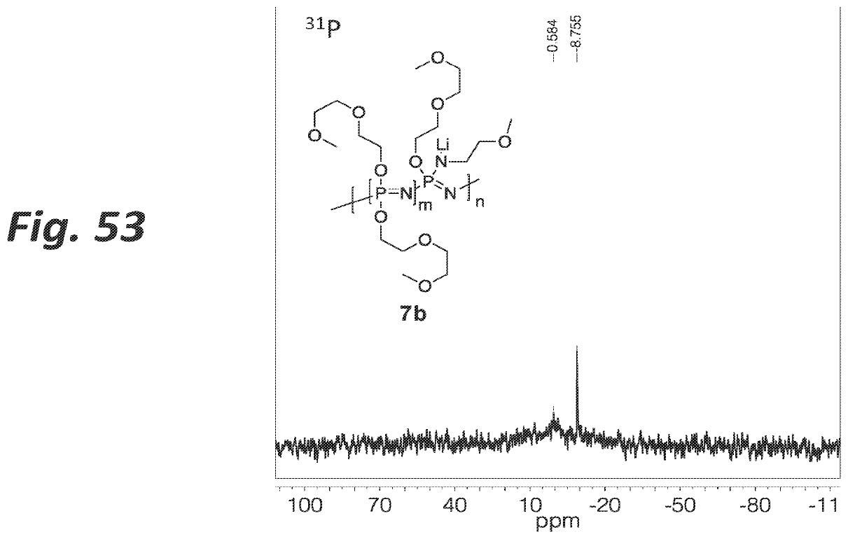

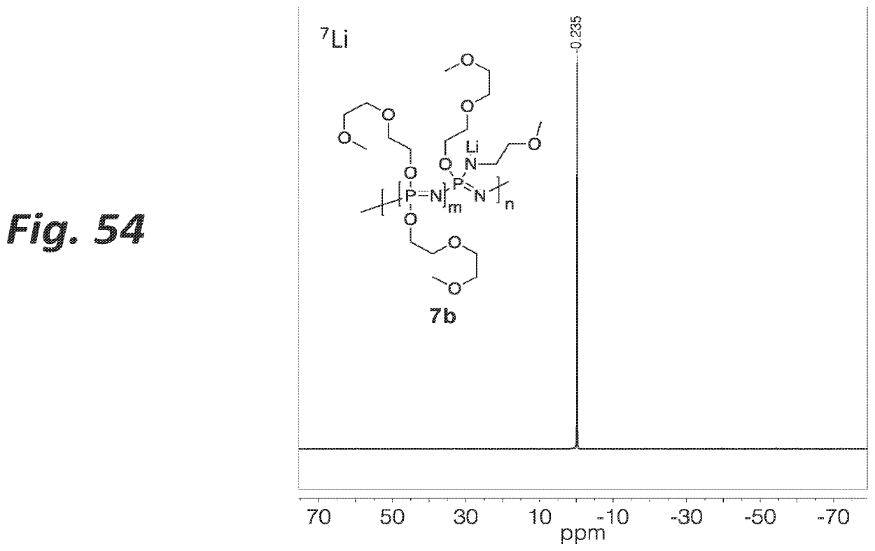

FIG. 51 illustrates an example synthesis procedure(s) utilized for the formation of 7b: (i) 6b (0.66 g, 2.4 mmol) was dissolved in 150 mL of THF and cooled to −78° C. in a dry ice/acetone bath; (ii) n-butyllithium (in hexane, 2.6 mmol) was then slowly added via syringe to the polymer solution under inert conditions and stirred for four hours at −78° C. to lithiate the polymer; (iii) the reaction mixture was then warmed to room temperature, and the solvent evaporated. (iv) The crude polymer was then transferred to an Ar glovebox (H₂O<0.1 ppm) and re-dissolved in THF, and precipitated with hexane to remove soluble impurities. (v) The solid was separated via filtration before washing several times with anhydrous hexane and dried thoroughly under vacuum to give 0.58 g of 7a (87.7% yield). FIGS. 52-54 show examples of the NMR characterizations of the material(s) produced according to this procedure: ¹H NMR (δ, d₆-DMSO): 3.24 (broad, s, 3H), 3.35 (m, broad, 3H), 3.44 (m, broad, 2H), 3.53 (in, broad, 4H), 3.79 (s, broad 2H), 3.98 (in, broad, 2H), ³¹P NMR (δ, d₆-DMSO): —8.75 (s, P₁), 0.58 (m, broad, P₂); ⁷Li NMR (δ, d₆-DMSO): —0.23 (s, Li⁺N⁻).

### Example 12

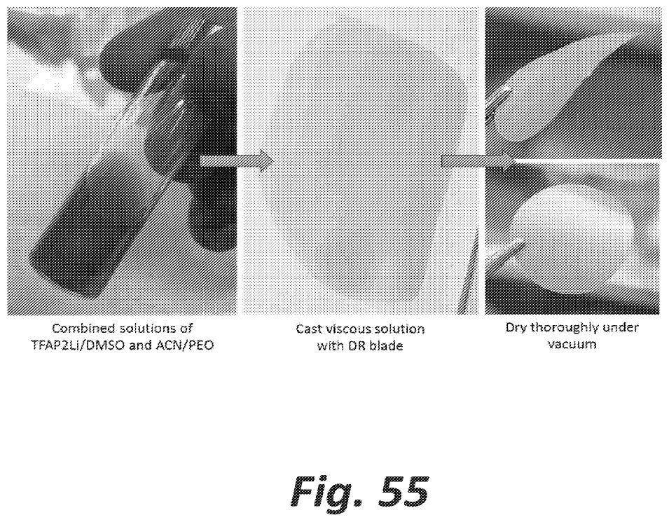

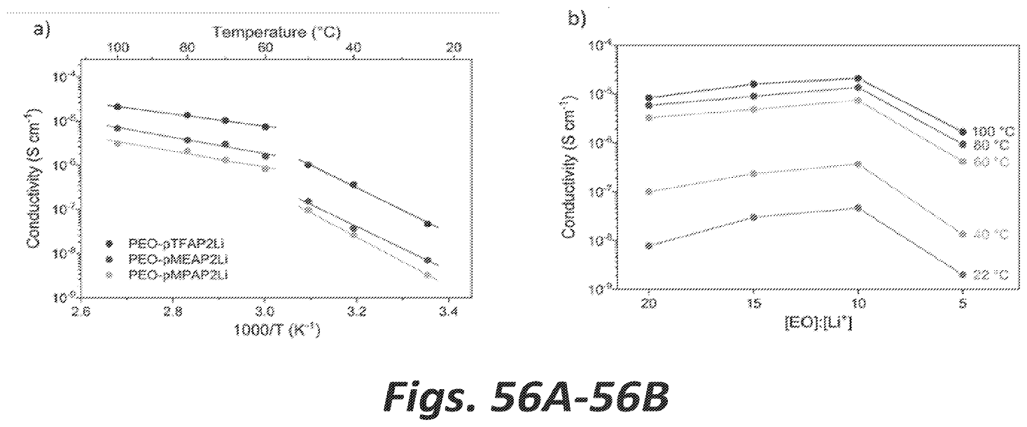

FIG. 56 shows the ionic conductivities of the SPEs comprising lithiated polyphosphazenes (3a, 3b, and 3c) blended with PEO based on EIS measurements. In FIG. 55, the method for the preparation of free-standing polymer electrolyte membranes is described. PEO-3a, PEO-3b, and PEO-3c polymer membranes were prepared by casting blended solutions of lithiated polyphosphazenes (3a, 3b, and 3c) with PEO at a 10:1 [EO]:[Li⁺] ratio for comparison (EO: one ethylene oxide repeat unit of PEO and two Li-ions per lithiated polyphosphazene repeat unit). These films were of the controllable thickness of −75 μm for this study. Note there was no plasticizer or added Li salt used in these studies. The ionic conductivity of the PEO-blended polyphosphazenes was determined by electrochemical impedance spectroscopy (EIS) in stainless steel symmetric cells (FIG. 56a). All blended electrolytes exhibit relatively low room temperature ionic conductivity (ca. 3×10⁻⁹ to 5×10⁻⁸ S cm⁻¹) but show a significant increase in conductivity around 60° C. when PEO transitions from a semi-crystalline phase to an amorphous phase with ionic conductivities between 6.9×10⁻⁶ and 2.1×10⁻⁵ S cm⁻¹ at 100° C. As such, one observes two linear regimes of ionic conductivity dependence on temperature. The Arrhenius behavior can be used to calculate the activation energy of each regime. The significantly greater activation energies (e.g., 1.0-1.1 eV at room temperature for 3a, 3b, and 3c blended SPEs; for comparison, other PEO/LiTFSI systems report activation energies around 0.5 eV at room temperature^{7, 8}) at lower temperatures demonstrates that all Li-ions are moderately/tightly ion-paired with the negatively charged nitrogen centers of lithiated polyphosphazenes (3a, 3b, and 3c) compared to highly dissociated salts such as LiTFSI. This suggests that the effect of PEO in minimizing the ion-pairing is marginal at lower temperatures when it is semi-crystalline, which limits the lower-temperature application of such produced SPEs. At higher temperatures (60° C.), the activation energies are considerably reduced (i.e., ionic conductivity increases), as thermal energies should minimize ion-pairing effects of the lithiated polymer (3a, 3b, and 3c), which should be further promoted by phase transition of PEO that aids Li-ion conduction by segmental motion.⁹ Comparing the three lithiated polyphosphazene blends (3a, 3b, and 3c; FIG. 56a), the PEO-3c system shows the highest ionic conductivity (2.1×10⁻⁵ S cm⁻¹ at 100° C.) and the lowest activation energy (Ea=0.28 eV). This is likely due to the inductive effect of the electron withdrawing CF₃ groups that weaken the ion pairing between the Li-ion and negatively charged nitrogen atom. FIG. 56b demonstrates the dependence of conductivity upon [EO]:[Li⁺], the ratio was varied from 5:1 up to 20:1 for the PEO-3c SPE. As expected, increasing the 3c content, thus increasing the number of charge carriers in the SPE, resulted in a marginal increase in conductivity; however, a limit was reached in the 5:1 SPE, where ionic conductivity decreased significantly. This is likely a result of reduced Li-ion mobility as dissociated ions transiently act as crosslinks between polymer chain segments and ultimately slow intrachain mobility at excessive charge carrier concentrations.

### Example 13

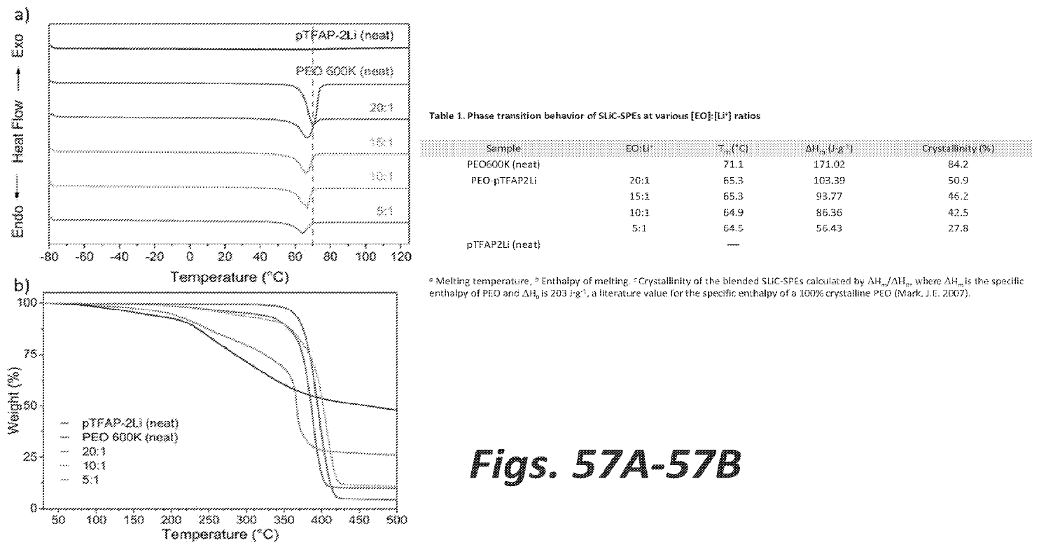

FIG. 57 provides the thermal properties of the PEO-3c electrolyte at various [EO]:[Li⁺] via differential scanning calorimetry (DSC) and thermogravimetric analysis (TGA) (FIGS. 57a and 57b, respectively). DSC revealed no other discernible phase transitions except the expected melting behavior of PEO. PEO melting temperature decreased with increasing 3c content, and it can be inferred that 3c has a plasticizing effect on the PEO polymer matrix, stabilizing the amorphous phase. This is consistent with the observed crystallinity trend, with the 5:1 blend being the least crystalline (Table 1). This is also consistent with the conductivity data as crystalline regions act as ionic insulators, and polymers that are more amorphous display higher ionic conductivity. TGA was used to probe the thermal stability of PEO-3c blends compared to the neat forms of the two constituents in the blend in FIG. 3b. Decomposition of the lithiated polyphosphazene limits the thermal stability to 208° C. for the blended SPE (PEO-3c), which is sufficient for most LIE applications.

### Example 14

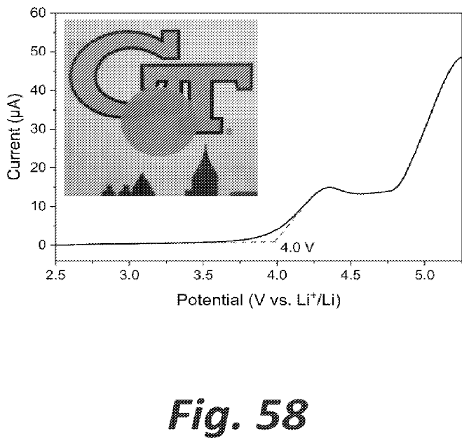

In FIG. 58, the ESW of the 10:1 PEO-3c blend was examined via linear-sweep voltammetry in an asymmetric cell with stainless steel as the working electrode and Li metal as the reference/counter electrode with a scan rate of 0.2 mV·s⁻¹. The blend was found to be oxidatively stable up to 4.0 V, after which the PEO matrix begins to oxidize (FIG. 4)^{12, 13} The second oxidation event at 4.7 V is likely a result of the oxidative decomposition of 3c. In total, it is established that any cell operation performed below 4.0 V (vs. Li/Li⁺) should likely ensure the stability of the PEO-3c SPE electrolyte. LFP, for which complete oxidation (deintercalation of lithium ions) can occur below 4.0 V (vs. Li/Li⁺), may thus be a suitable cathode material for examining the efficacy of PEO-3c as an electrolyte system, but not NCM for which a complete deintercalation would require >4.0 V potential.

### Example 15

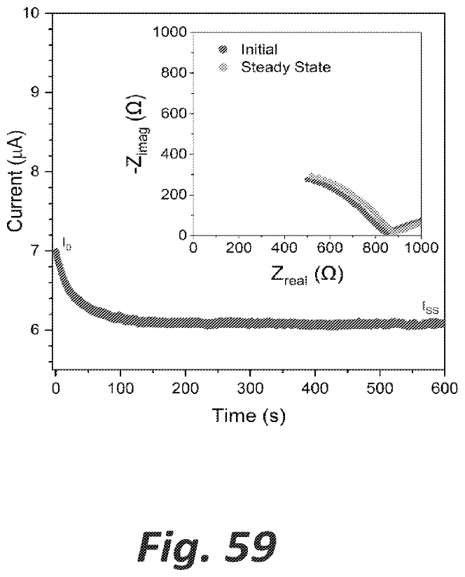

FIG. 59 shows the DC polarization chronoamperogram of the PEO-pTFAP2Li SPE in a lithium symmetric cell and impedance spectra used for determining the Li-ion transference number (t_{Li}+), From these data, the Bruce-Vincent method was used to calculate t_{Li}+=0.76.

### Example 16

To evaluate battery performance, the PEO-3c polymer electrolyte was assembled in a cell with a Li metal anode and LFP as the active cathode material (see an experimental section for details). Note that instead of using a traditional binder, PEO-3c served as both the cathode binder and the electrolyte (FIG. 60), which should improve the efficacy of ionic transport because commercial binders can block Li-ion transport and limit ionic conductivity within the cathode. However, this beneficial effect can be observed only if our SPE-conductive additive blend can coat the surface of all the cathode particles to afford maximum capacity utilization. Fortunately, scanning electron microscopy (SEM) images of both the top surface and cross-section of the cathode revealed a good “wetting” between the SPE and the LFP cathode particles (FIGS. 60b and 60c).

### Example 17

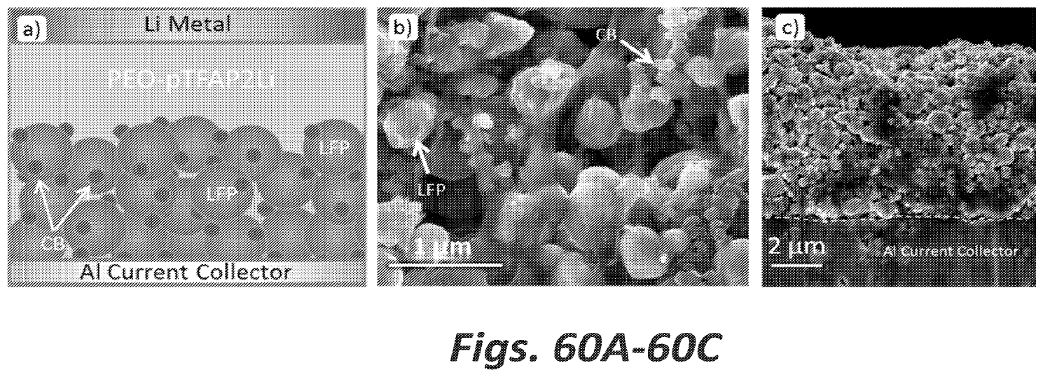

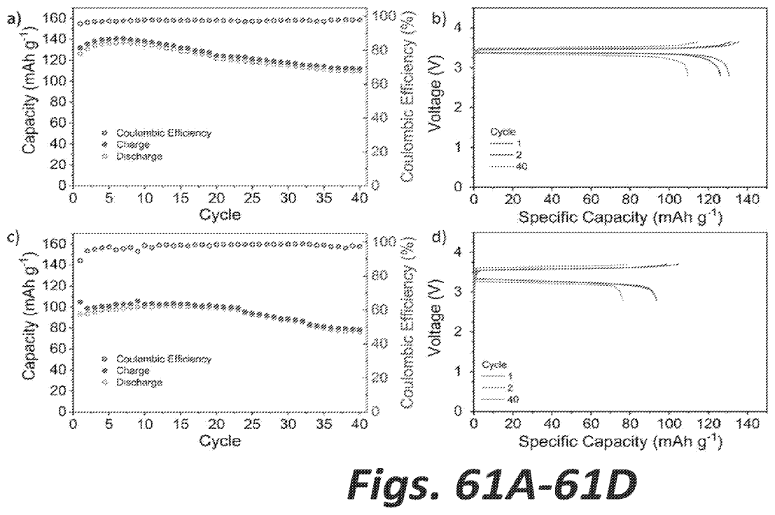

The electrochemical performance of Li |PEO-3c| LFP cells was evaluated at 100° C. at 0.05 C (FIGS. 61a and 61b) and 0.2 C rates (FIGS. 61c and 61d). At 0.05 C, the first cycle achieved a discharge capacity of 125 mAh g⁻¹ and continued to increase for the next six cycles before reaching a maximum discharge capacity of 137 mAh g⁻¹ (81% of LFP's theoretical capacity) (FIG. 61a). A slight decline in specific capacity is observed throughout the remaining cycles, with an overall 87.7% capacity retention for over 40 cycles. The cycling performance at 0.2 C exhibits similar behavior but with slightly lower values of capacities; the first cycle capacity with 93.4 mAh g⁻¹ increases to a maximum of 101 mAh g⁻¹, at the 14^{th} cycle (59.4% of LFP's theoretical capacity) with 81.8% capacity retained over 40 cycles (FIG. 61b). This increase in the first few cycles and subsequent gradual decrease in specific capacity is likely related to PEO being molten at the testing temperature. Initially, this creates better contact with cathode particles, and the SPE conforms nicely to the cathode and anode surface. The charge-discharge (C-D) curves plotted against the potential show typical behaviors of LFP cathodes (FIGS. 61c and 61d) and a higher polarization at the higher C— rate. A gradual increase in cell polarization correlates with the observed capacity decline.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove and that many modifications and other aspects are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

1-77. (canceled)

78. A polymer comprising monomer units of formula (I) 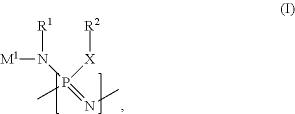
wherein R¹ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl-)(C₅₋₁₀ cycloalkenyl), C₁₋₁₂ haloalkyl, or —(C₀₋₅ alkyl)(C₃₋₁₀ heterocycloalkenyl);
R² is independently selected at each occurrence selected from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl-)(C₅₋₁₀ cycloalkenyl), C₁₋₁₂ haloalkyl, or —(C₀₋₅ alkyl)(C₃₋₁₀ heterocycloalkenyl);
R¹ and R² each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl,
X is O, S, or N-M¹; and
M¹ is Li, Na, or K.

79. The polymer of claim 78, wherein the polymer comprises:
monomer units of formula (Ia), wherein R¹ is different from R²;
monomer units of formula (Ib), wherein R¹ is the same as R²; or
a combination thereof.

80. The polymer of claim 78, wherein the polymer comprises:
monomer units of formula (Ia-N-M¹), wherein X is N-M¹ and R¹ is different from R²;
monomer units of formula (Ib-N-M¹), when X is N-M¹ and R¹ is the same as R²;
monomer units of formula (Ia-E), when X is O or S and R¹ is different from R²;
monomer units of has formula (Ib-E) when X is O or S and R¹ is the same as R²;
or a combination thereof.

81. The polymer of claim 78, wherein the polymer further comprises monomer units of formula (II): 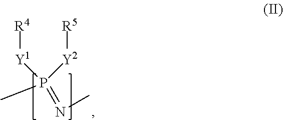
wherein R⁴ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl-)(C₅₋₁₀ cycloalkenyl), C₁₋₁₂ haloalkyl, or —(C₀₋₅ alkyl)(C₃₋₁₀ heterocycloalkenyl);
R⁵ is independently selected at each occurrence from hydrogen, C₁₋₁₂ alkyl, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), C₁₋₁₂ haloalkyl, or —(C₀₋₅ alkyl)(C₃₋₁₀ heterocycloalkenyl);
R⁴ and R⁵ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl, and
Y¹ and Y² are each independently selected from O or S.

82. The polymer of claim 81, wherein Y¹ and Y² are both O.

83. The polymer of claim 81, wherein the polymer comprises:
monomer units of formula (IIa), wherein R⁴ is different from R⁵;
monomer units of formula (IIb), wherein R⁴ is the same as R⁴;
or a combination thereof.

84. The polymer of claim 81, wherein R² is the same as R⁴, or R² is the same R⁵, or
R² is the same as both R⁴ and R⁵.

85. The polymer of claim 78, further comprising monomer units of formula (III): 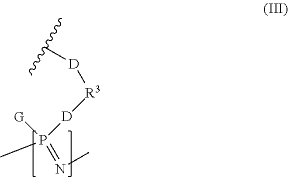
wherein the wavy line represents a bond to a phosphorus atom in a polymer chain;
G is R¹—N—, R²—X—, R⁴—Y—, or R⁵—Y—;
D is O, S, N; and
R³ is a linking group.

86. The polymer of claim 85, where R³ is selected from alkenylene, alkylene, or arylene, each optionally substituted by with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl-)(C₅₋₁₀ cycloalkenyl), —(C₀₋₅ alkyl)(C₃₋₁₀ heterocycloalkenyl), aldehyde, amino, carbonyl, ester, ether, dialkyl amines, thio-ethers, halo, carboxyl, hydroxy, nitro, sulfo-oxo, sulfonyl, fluorinated sulfonyl, sulfone, sulfoxide, thiol, or phosphonyl.

87. The polymer of claim 78, wherein M¹ is Li.

88. The polymer of claim 78, wherein X is independently selected from 0 and N-M¹.

89. The polymer of claim 78, wherein R¹, R², R⁴, and R⁵ are independently selected from C₁₋₁₂ alkyl and C₁₋₁₂ heteroalkyl, each optionally substituted one or more times by, independently halo or C₁₋₁₂ alkoxy.

90. The polymer of claim 78, wherein R¹ and R² are independently selected from (CH₂)ₓO-alkyl, (CH₂)ₓO(CH₂)ₓ(O)alkyl, and (CH₂)_{q}—CF₃, wherein x is 2-4 and q is 1-4,

91. A method of making the polymer of claim 78, comprising combining a polymer of Formula (IV): 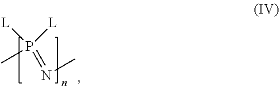
wherein
L is a leaving group selected from halo or OSO₃R,
R is —CH₃, —CF₃, —CH₂CH₃, aryl, alkyl, haloalkyl, wherein R is optionally substituted; and
n is greater or equal to 2,
with a compound having formula R¹—NH-M^{a} to form a polymer of formula (V): 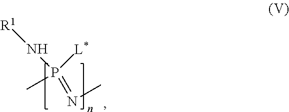
wherein
L* is L or R¹—N-M^{a};
M^{a} is H or Li, Na, or K, and
n is greater or equal to 2; and
combining the polymer of formula (V) with a compound having formula M^{b}-X′—R² to provide a polymer comprising monomer units of formula (VI): 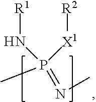
wherein X′ is O, S, or N-M^{b}, and M^{b} is H or Li, Na, or K.

92. A composition comprising the polymer of claim 78, and an organic solvent, a metal salt, a ceramic additive, or a combination thereof.

93. The composition of claim 92, where the organic solvent comprises ethyl carbonate, propylene carbonate, polyethylene glycol dimethyl ether, tetraglyme, dibutyl phthalate, modified carbonate, polyethylene glycol, dimethyl phthalate, diethyl phthalate, dioctyl phthalate, cyclic phosphates, succinonitrile, ethyl propionate, ethyl acetate, dimethyl carbonate, ethyl methyl carbonate, diethyl carbonate, fluoroethylene carbonate, vinylene carbonate, or a combination thereof.

94. The composition of claim 92, wherein the metal salt comprises a cation comprising Li, K, Na, Al, Mg, Zn, Ca, or a combination thereof, and an anion comprising bistriflilmide (TFSI⁻), bis(fluorosulfonyl)imide) (FSI⁻), triflate (OTf⁻), hexafluorophosphate (PF₆⁻), hexafluroarsenate (AsF₆⁻), fluoride (F⁻), aluminum tetrachloride (AlCl₄⁻), boron tetrachloride (BCl₄⁻), boron tetrafluoride (BF₄⁻), iodide (I⁻), chloride (Cl⁻) chlorate (ClO₃⁻), bromide (Br⁻), bromate (BrO₃⁻), iodate (IO₃⁻), difluoro(oxalato)borate (DFOB⁻), bis(oxalato)borate (BOB⁻), difluorophosphate (DFP), or a combination thereof.

95. The composition of claim 92, further comprising poly(ethyleneoxide) (PEO), polytetrafluoroethylene (PTFE), polyvinylidene fluoride (PVDF), polyvinylidene, fluoride-co-hexafluoropropylene (PVDF-HFP), polystyrene, (PS), polybutadiene (BR), polyvinylidene chloride (VDC), polymethyl methacrylate (PMMA), polyvinyl alcohol, (PVAL), polyvinyl acetate (PVA), polyphenylene oxide, (PPO), polyether ether ketone (PEEK), polyethylene terephthalate (PET), polybutylene terephthalate (PBT), polycarbonate (PC), polyether sulfone, polybenzimidazoles (PBI), polydimethylsiloxane, polyphenylene sulfide (PS), polypyrrole, polyphenylene, polyaniline, poly[bis(pentoxy)phosphazene], poly[bis(phenoxy)phosphazene], poly[(methoxyethoxyethoxy)(m-methyl phenoxy)phosphazene], or a combination thereof.

96. A separator for a battery, comprising the polymer of claim 78.

97. A battery, comprising an anode, a cathode, and an electrolyte, wherein the electrolyte comprises the polymer of claim 78.
